(19) United States
(12) Patent Application Publication
(10) Pub. No.: US 2020/0349367 A1
(43) Pub. Date: Nov. 5, 2020

(54) IMAGE PROCESSING DEVICE, IMAGE PROCESSING METHOD, AND PROGRAM

(71) Applicant: SONY CORPORATION, TOKYO (JP)

(72) Inventors: TOSHIYUKI SASAKI, TOKYO (JP); KAZUNORI KAMIO, KANAGAWA (JP)

(21) Appl. No.: 16/960,459

(22) PCT Filed: Jan. 4, 2019
(86) PCT No.: PCT/JP2019/000031

§ 371 Date: Jul. 7, 2020

(30) Foreign Application Priority Data
Jan. 19, 2018 (JP) 2018-007149

(51) Int. Cl. G06K 9/00; G06T 7/246; G06T 7/292; B60W 40/04

(52) U.S. Cl. CPC G06K 9/00805; G06T 7/251; B60W 2554/4042; B60W 40/04; B60W 2554/4041; G06T 7/292

(57) ABSTRACT

The present disclosure relates to an image processing device, an image processing method, and a program that can make it easier to check a surrounding situation. A viewpoint determination part determines a viewpoint of a viewpoint image related to periphery of a moving object in a case where the moving object is viewed from a predetermined viewpoint, according to a speed of a vehicle that can move at an arbitrary speed. Then, an image synthesis part synthesizes an illustrative image of the vehicle at a position where the vehicle can exist in the captured image of the periphery of the vehicle, and a projection conversion part performs projection conversion on an image obtained by the image synthesis part synthesizing the illustrative image of the vehicle to generate the viewpoint image that is a view from the viewpoint determined by the viewpoint determination part. The present technology can be applied to, for example, an image processing device mounted on a vehicle.

### TECHNICAL FIELD

The present disclosure relates to an image processing device, an image processing method, and a program, and more particularly, to an image processing device, an image processing method, and a program that can make it easier to check a surrounding situation.

### BACKGROUND ART

Conventionally, an image processing device has been put to practical use, in which image processing of converting an image captured at a wide angle by a plurality of cameras mounted on a vehicle into an image of view of looking down the periphery of the vehicle from above is performed and the result image is presented to a driver for the purpose of use in parking of a vehicle. Furthermore, with the spread of automatic driving in the future, it is expected that the surrounding situation can be checked even during traveling.

For example, Patent Document 1 discloses a vehicle periphery monitoring device that switches a viewpoint for viewing a vehicle and presents it to a user in accordance with a shift lever operation or a switch operation.

### CITATION LIST

### Patent Document

Patent Document 1: Japanese Patent Application Laid-Open No. 2010-221980

### SUMMARY OF THE INVENTION

### Problems to be Solved by the Invention

However, in the vehicle periphery monitoring device as described above, since it is not considered that the viewpoint is switched according to the speed of the vehicle, for example, it is assumed that, when a vehicle travels at high speed, a sufficient front view is not ensured with respect to the speed of the vehicle so that checking the surrounding situation is difficult. Furthermore, since operation information of a shift lever is used in switching the viewpoint, it is necessary to process a signal via an electronic control unit (ECU), which may cause a delay.

The present disclosure has been made in view of such a situation, and is intended to make it easier to check a surrounding situation.

### Solutions to Problems

An image processing device according to an aspect of the present disclosure includes: a determination part that determines a predetermined viewpoint of a viewpoint image related to periphery of a moving object in a case of viewing the moving object from the viewpoint according to a speed of the moving object that can move at an arbitrary speed; a generation part that generates the viewpoint image that is a view from the viewpoint determined by the determination part; and a synthesis part that synthesizes an image related to the moving object at a position where the moving object can exist in the viewpoint image.

An image processing method according to an aspect of the present disclosure includes, by an image processing device that performs image processing: determining a predetermined viewpoint of a viewpoint image related to periphery of a moving object in a case of viewing the moving object from the viewpoint according to a speed of the moving object that can move at an arbitrary speed; generating the viewpoint image that is a view from the viewpoint determined; and synthesizing an image related to the moving object at a position where the moving object can exist in the viewpoint image.

A program according to an aspect of the present disclosure causes a computer of an image processing device that performs image processing to perform image processing including: determining a predetermined viewpoint of a viewpoint image related to periphery of a moving object in a case of viewing the moving object from the viewpoint according to a speed of the moving object that can move at an arbitrary speed; generating the viewpoint image that is a view from the viewpoint determined; and synthesizing an image related to the moving object at a position where the moving object can exist in the viewpoint image.

In an aspect of the present disclosure, a predetermined viewpoint of a viewpoint image related to periphery of a moving object in a case of viewing the moving object from the viewpoint is determined according to a speed of the moving object that can move at an arbitrary speed, the viewpoint image that is a view from the viewpoint determined is generated, and an image related to the moving object is synthesized at a position where the moving object can exist in the viewpoint image.

### Effects of the Invention

According to an aspect of the present disclosure, it is possible to make it easier to check a surrounding situation.

Note that the effects described herein are not necessarily limited, and any of the effects described in the present disclosure may be applied.

### BRIEF DESCRIPTION OF DRAWINGS

FIG. 1 is a block diagram showing a configuration example of an image processing device according to an embodiment to which the present technology is applied.

FIG. 2 is a diagram for explaining distortion correction processing.

FIG. 3 is a diagram showing an example of a viewpoint set for a vehicle when the vehicle is stationary.

FIG. 4 is a diagram showing an example of a viewpoint set for a vehicle when the vehicle is moving forward.

FIG. 5 is a diagram showing an example of a viewpoint set for a vehicle when the vehicle is traveling at high speed.

FIG. 6 is a diagram showing an example of a viewpoint set for a vehicle when the vehicle is moving backward.

FIG. 7 is a diagram for explaining correction of an origin.

FIG. 8 is a block diagram showing a first configuration example of a viewpoint conversion image generation part.

FIG. 9 is a diagram for explaining an image synthesizing result.

FIG. 10 is a block diagram showing a second configuration example of the viewpoint conversion image generation part.

FIG. 11 is a diagram for explaining matching of corresponding points on an obstacle.

FIG. 12 is a block diagram showing a configuration example of a viewpoint determination part.

FIG. 13 is a diagram defining a parameter r, a parameter θ, and a parameter φ.

FIG. 14 is a diagram showing an example of a look-up table of the parameter r and the parameter θ.

FIG. 15 is a diagram for explaining conversion of polar coordinates into rectangular coordinates.

FIG. 16 is a diagram showing an example of a lookup table of an origin correction vector Xdiff.

FIG. 17 is a flowchart for explaining image processing.

FIG. 18 is a flowchart for explaining a first processing example of viewpoint conversion image generation processing.

FIG. 19 is a flowchart for explaining a second processing example of the viewpoint conversion image generation processing.

FIG. 20 is a diagram showing an example of a vehicle equipped with the image processing device.

FIG. 21 is a block diagram showing a configuration example of a computer according to an embodiment to which the present technology is applied.

FIG. 22 is a block diagram showing a schematic configuration example of a vehicle control system.

FIG. 23 is an explanatory diagram showing an example of installation positions of a vehicle exterior information detection part and an imaging part.

### MODE FOR CARRYING OUT THE INVENTION

Specific embodiments to which the present technology is applied will be described in detail below with reference to the drawings.

<Configuration Example of Image Processing Device>

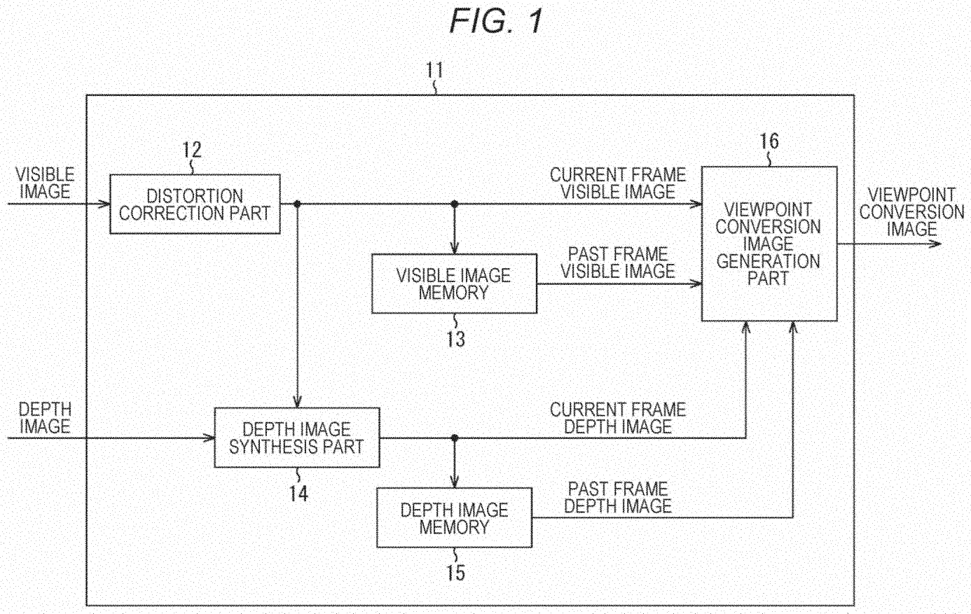

FIG. 1 is a block diagram showing a configuration example of an image processing device according to an embodiment to which the present technology is applied.

As shown in FIG. 1, an image processing device 11 includes a distortion correction part 12, a visible image memory 13, a depth image synthesis part 14, a depth image memory 15, and a viewpoint conversion image generation part 16.

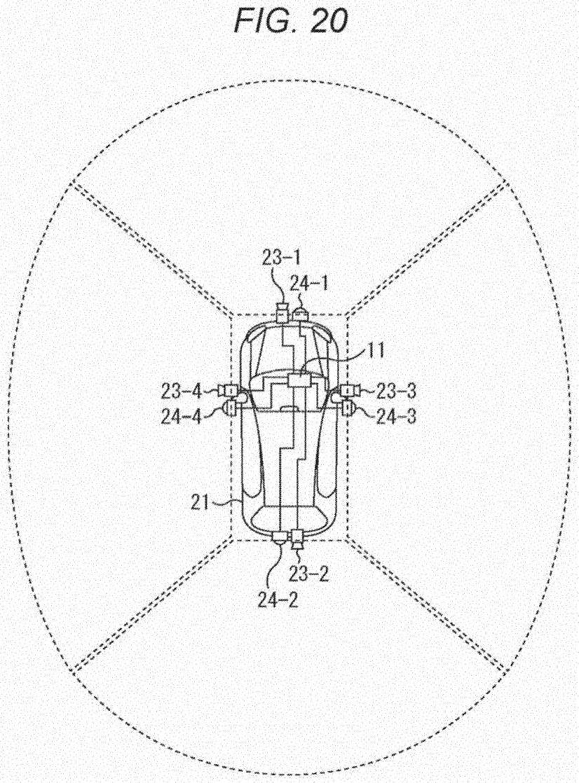

For example, the image processing device 11 is used by being mounted on a vehicle 21 as shown in FIG. 20 described later. The vehicle 21 includes a plurality of RGB cameras 23 and distance sensors 24. Then, the image processing device 11 is supplied with a wide-angle and high-resolution visible image acquired by capturing the periphery of the vehicle 21 by the plurality of RGB cameras 23, and is supplied with a narrow-angle and low-resolution depth image acquired by sensing the periphery of the vehicle 21 by the plurality of distance sensors 24.

Then, the distortion correction part 12 of the image processing device 11 is supplied with a plurality of visible images from each of the plurality of RGB cameras 23, and a depth image synthesis part 14 of the image processing device 11 is supplied with a plurality of depth images from each of the plurality of the distance sensors 24.

The distortion correction part 12 performs distortion correction processing of correcting distortion occurring in a wide-angle and high-resolution visible image supplied from the RGB camera 23 due to capturing at a wide angle of view. For example, correction parameters according to the lens design data of the RGB camera 23 are prepared in advance for the distortion correction part 12. Then, the distortion correction part 12 divides the visible image into a plurality of small blocks, converts the coordinates of each pixel in each small block into coordinates after correction according to the correction parameters, transfers the converted coordinates, complements a gap in a pixel of a transfer destination with a Lanczos filter or the like, and then clips the complemented one into a rectangle. Through such distortion correction processing, the distortion correction part 12 can correct distortion occurring in a visible image acquired by capturing at a wide angle.

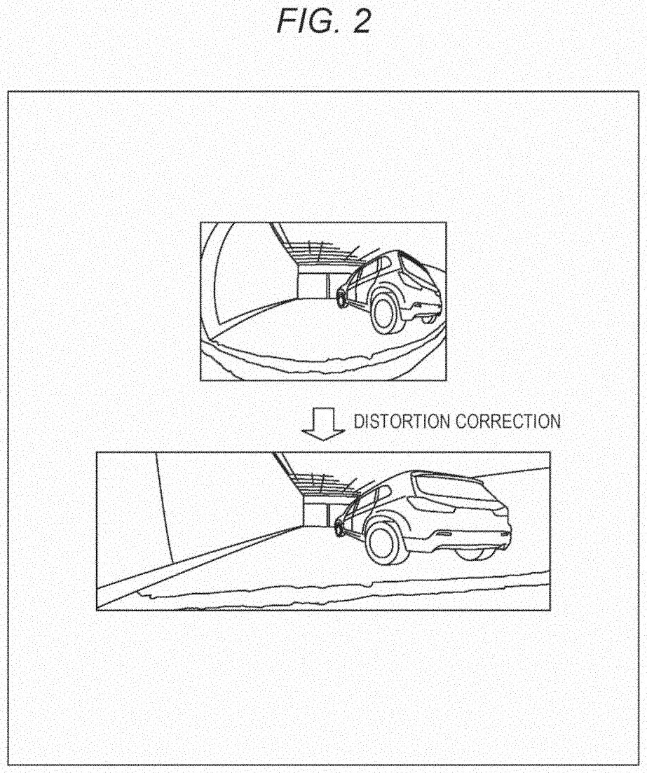

For example, the distortion correction part 12 applies distortion correction processing to a visible image in which distortion has occurred as shown in the upper side of FIG. 2 so that a visible image in which the distortion is corrected (that is, the straight line portion is represented as a straight line) as shown in the lower side of FIG. 2 can be acquired. Then, the distortion correction part 12 supplies the visible image in which the distortion is corrected to the visible image memory 13, the depth image synthesis part 14, and the viewpoint conversion image generation part 16. Note that, in the following, the visible image which is acquired by the distortion correction part 12 applying the distortion correction processing to the latest visible image supplied from the RGB camera 23 and is supplied to the viewpoint conversion image generation part 16 is referred to as a current frame visible image as appropriate.

The visible image memory 13 stores the visible images supplied from the distortion correction part 12 for a predetermined number of frames. Then, the past visible image stored in the visible image memory 13 is read out from the visible image memory 13 as a past frame visible image at a timing necessary for performing processing in the viewpoint conversion image generation part 16.

The depth image synthesis part 14 uses the visible image that has been subjected to the distortion correction and is supplied from the distortion correction part 12 as a guide signal, and performs synthesizing processing to improve the resolution of the depth image obtained by capturing the direction corresponding to each visible image. For example, the depth image synthesis part 14 can improve the resolution of the depth image, which is generally sparse data, by using a guided filter that expresses the input image by linear regression of the guide signal. Then, the depth image synthesis part 14 supplies the depth image with the improved resolution to the depth image memory 15 and the viewpoint conversion image generation part 16. Note that, in the following, the depth image that is obtained by the depth image synthesis part 14 performing synthesizing processing on the latest depth image supplied from the distance sensor 24 and is supplied to the viewpoint conversion image generation part 16 is referred to as a current frame depth image as appropriate.

The depth image memory 15 stores the depth images supplied from the depth image synthesis part 14 for a predetermined number of frames. Then, the past depth image stored in the depth image memory 15 is read from the depth image memory 15 as a past frame depth image at a timing necessary for performing processing in the viewpoint conversion image generation part 16.

For example, the viewpoint conversion image generation part 16 generates a viewpoint conversion image by performing the viewpoint conversion for a current frame visible image supplied from the distortion correction part 12, or a past frame visible image read from the visible image memory 13, such that the viewpoint looks down the vehicle 21 from above. Moreover, the viewpoint conversion image generation part 16 can generate a more optimal viewpoint conversion image by using the current frame depth image supplied from the depth image synthesis part 14 and the past frame depth image read from the depth image memory 15.

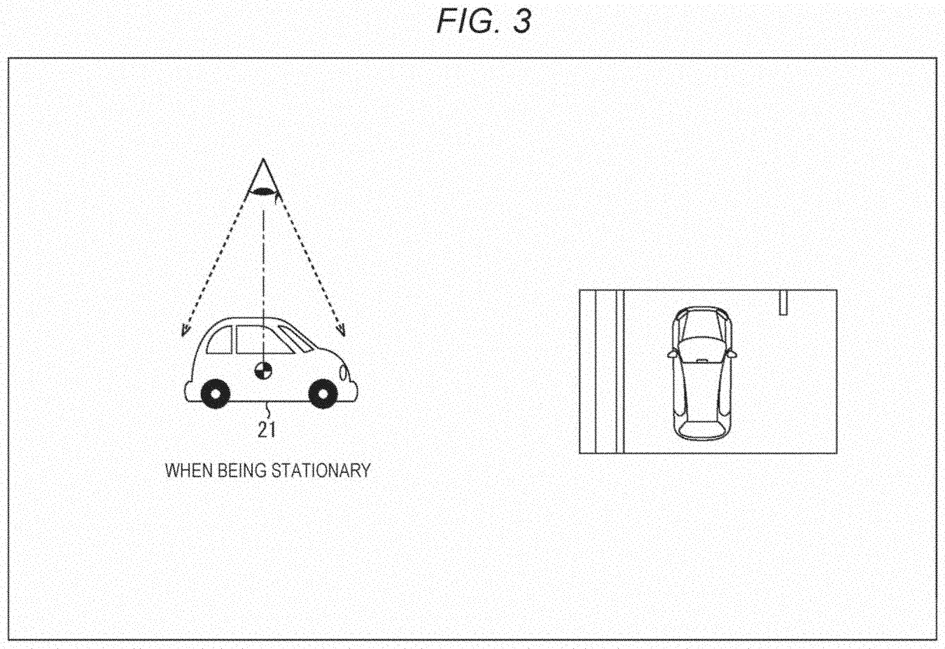

At this time, the viewpoint conversion image generation part 16 can set the viewpoint so that a viewpoint conversion image that looks down the vehicle 21 at an optimal viewpoint position and line-of-sight direction can be generated according to the traveling direction and the vehicle speed of the vehicle 21. Here, with reference to FIGS. 3 to 7, a viewpoint position and a line-of-sight direction of the viewpoint set at the time the viewpoint conversion image generation part 16 generates the viewpoint conversion image will be described.

For example, as shown in FIG. 3, when the vehicle 21 is stationary, the viewpoint conversion image generation part 16 uses the center of the vehicle 21 as the origin, and sets the viewpoint so that the line-of-sight direction is a direction toward the origin right below from the viewpoint position right above the center of the vehicle 21, as shown by a dashed line. Therefore, as shown on the right side of FIG. 3, a viewpoint conversion image that looks down the vehicle 21 from directly above the vehicle 21 to below is generated.

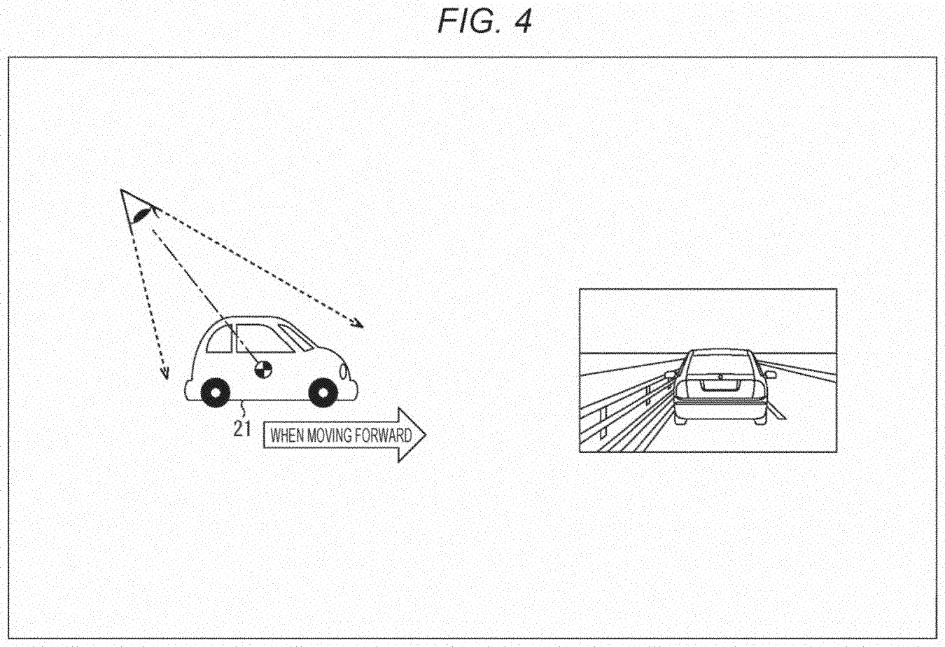

Furthermore, as shown in FIG. 4, when the vehicle 21 is moving forward, the viewpoint conversion image generation part 16 uses the center of the vehicle 21 as the origin, and sets the viewpoint so that the line-of-sight direction is a direction toward the origin obliquely front downward from the viewpoint position obliquely above rearward the vehicle 21, as shown by a dashed line. Therefore, as shown on the right side of FIG. 4, a viewpoint conversion image that looks down the traveling direction of the vehicle 21 from obliquely above rearward to obliquely forward downward of the vehicle 21 is generated.

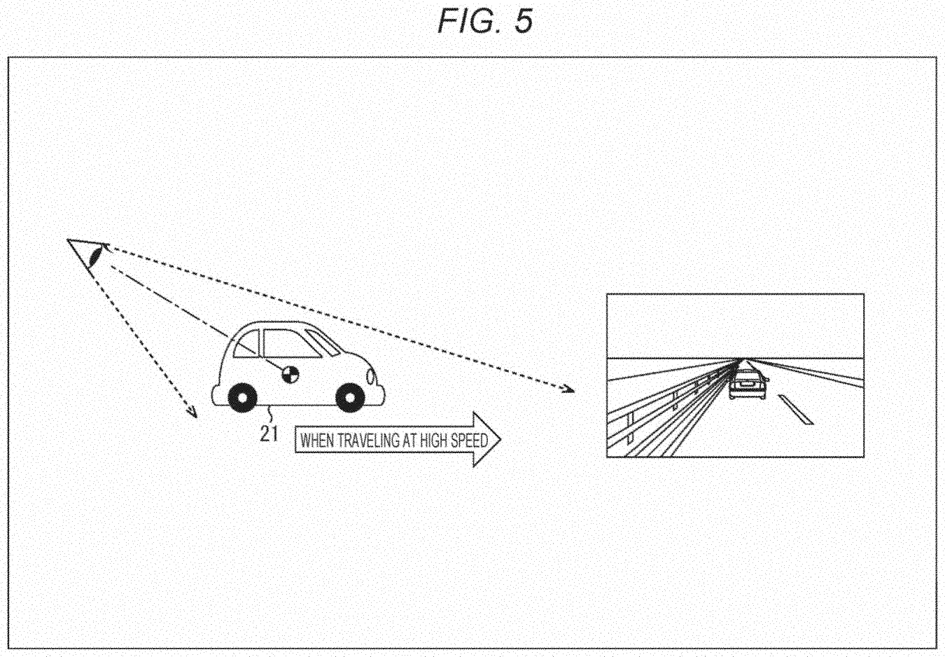

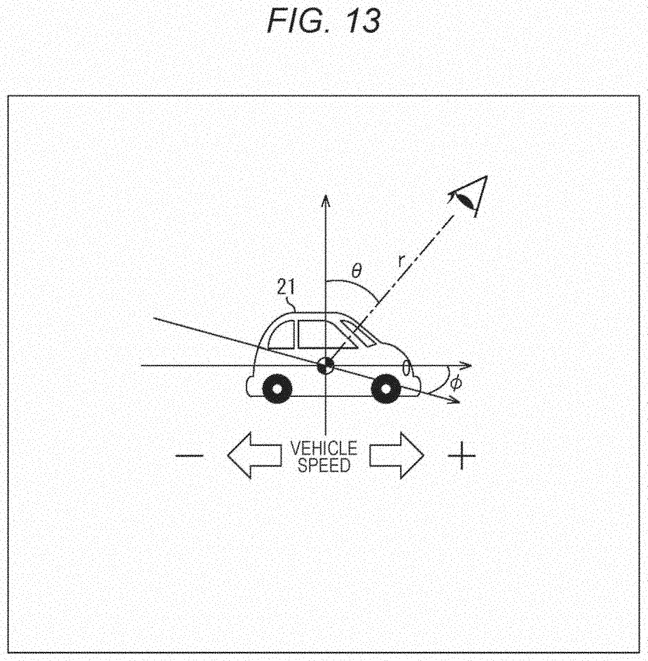

Moreover, as shown in FIG. 5, when the vehicle 21 travels at high speed, the viewpoint conversion image generation part 16 uses the center of the vehicle 21 as the origin, and sets the viewpoint so that the line-of-sight direction is a low line-of-sight toward the origin obliquely front downward from the viewpoint position obliquely above further rearward than that at the time of moving forward, as shown by a dashed line. That is, the viewpoint is set such that, as the speed of the vehicle 21 increases, the angle (θ shown in FIG. 13 as described later) of the line-of-sight to the vertical direction shown by the dashed line increases from the viewpoint to the origin. For example, in a case where the speed of the vehicle 21 is a first speed, the viewpoint is set such that the angle of the line-of-sight direction to the vertical direction is larger than that in a case of a second speed where the speed of the vehicle 21 is lower than the first speed. Therefore, as shown on the right side of FIG. 5, a viewpoint conversion image that looks down the traveling direction of the vehicle 21 from obliquely above rearward to obliquely forward downward of the vehicle 21 over a wider range than in a case of traveling forward is generated.

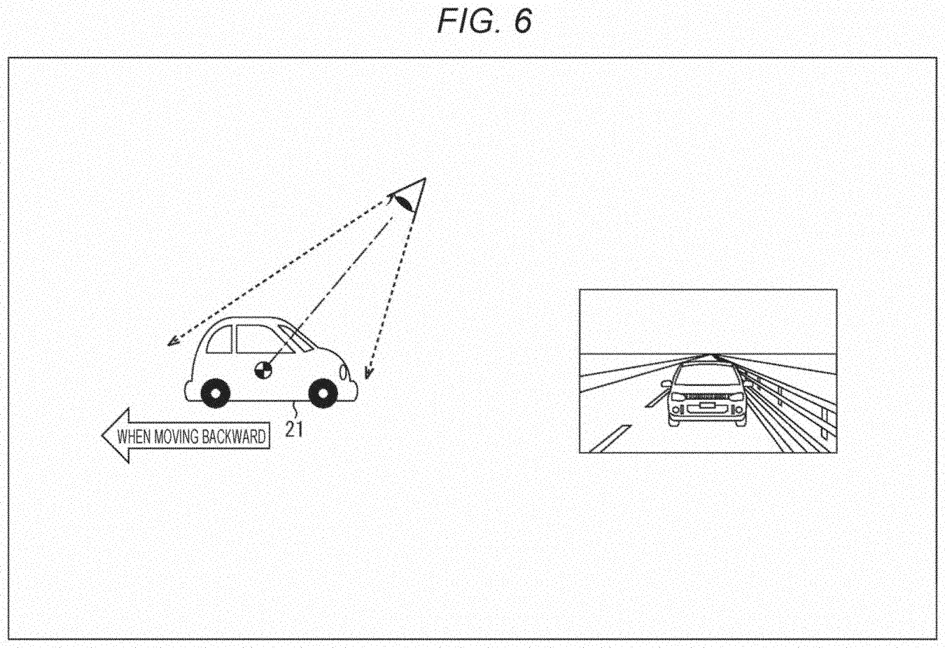

On the other hand, as shown in FIG. 6, when the vehicle 21 is moving backward, the viewpoint conversion image generation part 16 uses the center of the vehicle 21 as the origin, and sets the viewpoint so that the line-of-sight direction is a direction toward the origin obliquely rear downward from the viewpoint position obliquely above upward the vehicle 21, as shown by a dashed line. Therefore, as shown on the right side of FIG. 6, a viewpoint conversion image that looks down the opposite of the traveling direction of the vehicle 21 from obliquely above forward to obliquely rear downward of the vehicle 21 is generated. Note that the viewpoint is set such that the angle of the line-of-sight to the vertical direction is larger when the vehicle 21 is moving forward than when the vehicle 21 is moving backward.

Note that the viewpoint conversion image generation part 16 can set the origin of the viewpoint (gaze point) at the time of generating the viewpoint conversion image fixedly to the center of the vehicle 21 as shown in FIGS. 3 to 6, and, in addition to that, can set the origin to the point other than the center of the vehicle 21.

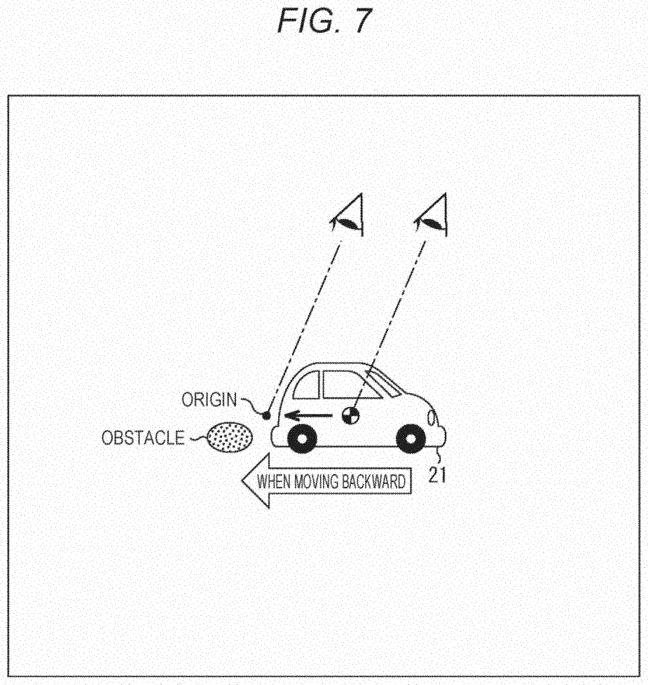

For example, as shown in FIG. 7, when the vehicle 21 is moving backward, the viewpoint conversion image generation part 16 can set the origin at a position moved to the rear of the vehicle 21. Then, the viewpoint conversion image generation part 16 sets the viewpoint so that the line-of-sight direction is a direction toward the origin obliquely rear downward from the viewpoint position obliquely above upward the vehicle 21, as shown in the drawing by a dashed line. This makes it easier to recognize an obstacle at the rear of the vehicle 21 in the example shown in FIG. 7 than in the example of FIG. 6 in which the origin is set at the center of the vehicle 21, and a viewpoint conversion image with high visibility can be generated.

The image processing device 11 configured as described above can set the viewpoint according to the speed of the vehicle 21 to generate the viewpoint conversion image that makes it easier to check the surrounding situation, and present the viewpoint conversion image to the driver. For example, the image processing device 11 can set the viewpoint such that a distant visual field can be sufficiently secured during high-speed traveling, so that viewing can be made easier and driving safety can be improved.

<First Configuration Example of Viewpoint Conversion Image Generation Part>

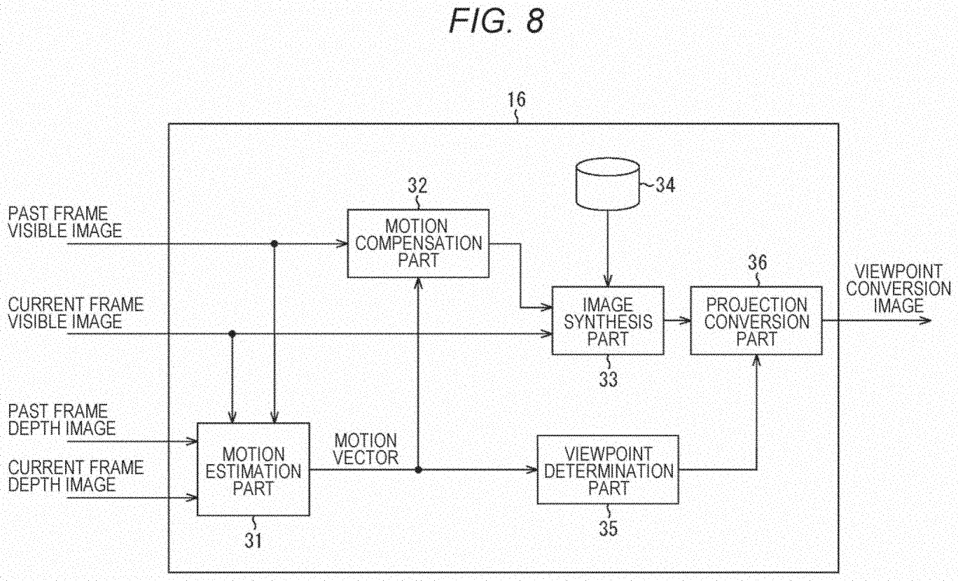

FIG. 8 is a block diagram showing a first configuration example of the viewpoint conversion image generation part 16.

As shown in FIG. 8, the viewpoint conversion image generation part 16 includes a motion estimation part 31, a motion compensation part 32, an image synthesis part 33, a storage part 34, a viewpoint determination part 35, and a projection conversion part 36.

The motion estimation part 31 uses the current frame visible image and the past frame visible image, as well as the current frame depth image and the past frame depth image to estimate a motion of an object (hereinafter, referred to as a moving object) that is moving and captured in those images. For example, the motion estimation part 31 performs a motion vector search (motion estimation: ME) on the same moving object captured in the visible images of a plurality of frames to estimate the motion of the moving object. Then, the motion estimation part 31 supplies a motion vector determined as a result of estimating the motion of the moving object to the motion compensation part 32 and the viewpoint determination part 35.

The motion compensation part 32 performs motion compensation (MC) of compensating the moving object captured in a certain past frame visible image to the current position on the basis of the motion vector of the moving object supplied from the motion estimation part 31. Therefore, the motion compensation part 32 can correct the position of the moving object captured in the past frame visible image so as to match the moving object to the position where the moving object should be located currently. Then, the past frame visible image subjected to the motion compensation is supplied to the image synthesis part 33.

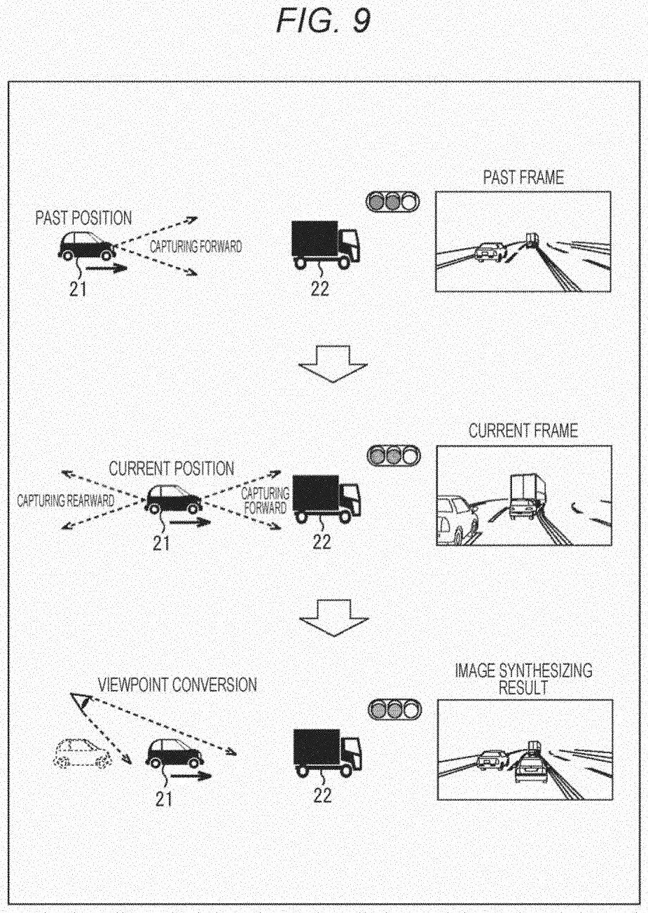

The image synthesis part 33 reads the illustrative image of the vehicle 21 from the storage part 34, and generates an image synthesizing result (see FIG. 9 described later) of synthesizing the illustrative image of the vehicle 21 according to the current position that is a position where the vehicle 21 should be located currently (the position where the vehicle 21 can exist) in the past frame visible image where the motion compensation has been performed by the motion compensation part 32. Note that when the vehicle 21 is stationary, the image synthesis part 33 generates the image synthesizing result obtained by synthesizing the illustrative image of the vehicle 21 according to the current position of the vehicle 21 in the current frame visible image. Then, the image synthesis part 33 supplies the generated image synthesizing result to the projection conversion part 36.

The storage part 34 stores, as advance information, data of the illustrative image of the vehicle 21 (image data that is related to the vehicle 21 and is of the vehicle 21 viewed from the rear or the front).

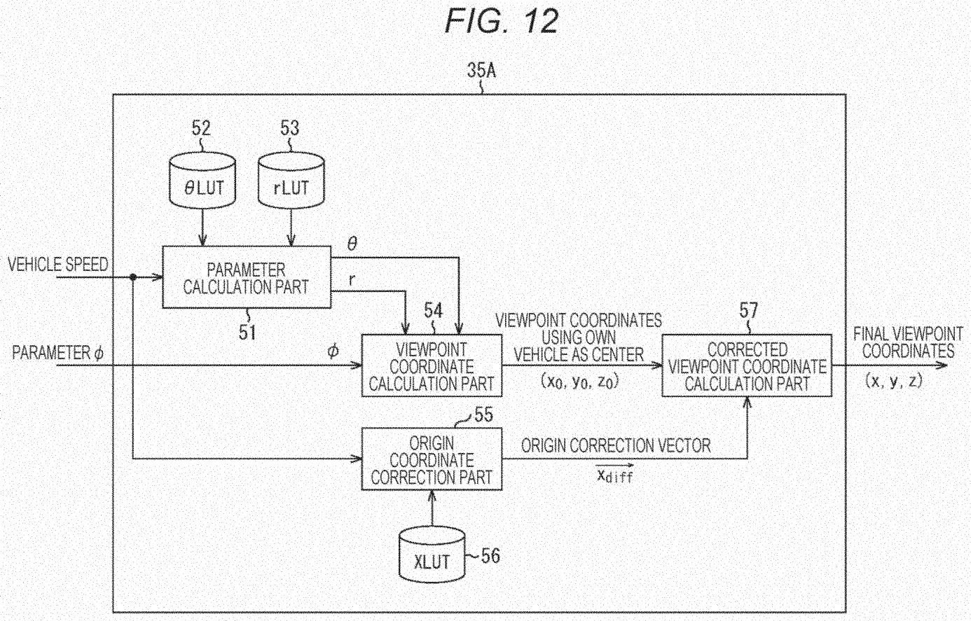

The viewpoint determination part 35 first calculates the speed of the vehicle 21 on the basis of the motion vector supplied from the motion estimation part 31. Then, the viewpoint determination part 35 determines a viewpoint at the time of generating a viewpoint conversion image that is a view from the viewpoint so that the viewpoint is of the viewpoint position and the line-of-sight direction according to the calculated speed of the vehicle 21, and supplies information indicating the viewpoint (for example, viewpoint coordinates (x, y, z) described with reference to FIG. 12 described later, or the like) to the projection conversion part 36. Note that the viewpoint determination part 35 may determine the speed of the vehicle 21 from visible images of at least two frames captured at different timings, and determine the viewpoint according to the speed.

The projection conversion part 36 applies projection conversion to the image synthesizing result supplied from the image synthesis part 33 so that the image is a view from the viewpoint determined by the viewpoint determination part 35. Therefore, the projection conversion part 36 can acquire the viewpoint conversion image in which the viewpoint is changed according to the speed of the vehicle 21, and for example, outputs the viewpoint conversion image to a head-up display, a navigation device, and a subsequent display device such as an external device (not shown).

Here, the image synthesizing result output from the image synthesis part 33 will be described with reference to FIG. 9.

For example, as shown in the upper part of FIG. 9, at the past position that is the position of the vehicle 21 at a certain point in time past the current time, a past frame visible image in which the front of the vehicle 21 is captured is read from the visible image memory 13, and is supplied to the image synthesis part 33. At this time, another vehicle 22 located in front of the vehicle 21 is located farther than the vehicle 21, and is smaller in the past frame visible image.

Thereafter, as shown in the middle part of FIG. 9, at the current position of the vehicle 21 at the current time when the vehicle 21 approaches the another vehicle 22, in the current frame visible image that is a visible image obtained by capturing forward of the vehicle 21, the another vehicle 22 is larger than in the past frame visible image.

At this time, the image synthesis part 33 can synthesize the illustrative image of the vehicle 21 viewed from backward with respect to the past frame visible image of the current position of the vehicle 21 as viewed from the backward at the current position of the vehicle 21 to output the image synthesizing result as shown in the lower part of FIG. 9. Then, thereafter, the projection conversion is performed by the projection conversion part 36 so that the viewpoint conversion is performed such that the viewpoint of looking down from above.

As described above, the viewpoint conversion image generation part 16 can generate the viewpoint conversion image in which the viewpoint is set according to the speed of the vehicle 21. At this time, in the viewpoint conversion image generation part 16, since the viewpoint determination part 35 can internally determine the speed of the vehicle 21, for example, the processing of an electronic control unit (ECU) is not required, and the viewpoint can be determined with a low delay.

<Second Configuration Example of Viewpoint Conversion Image Generation Part>

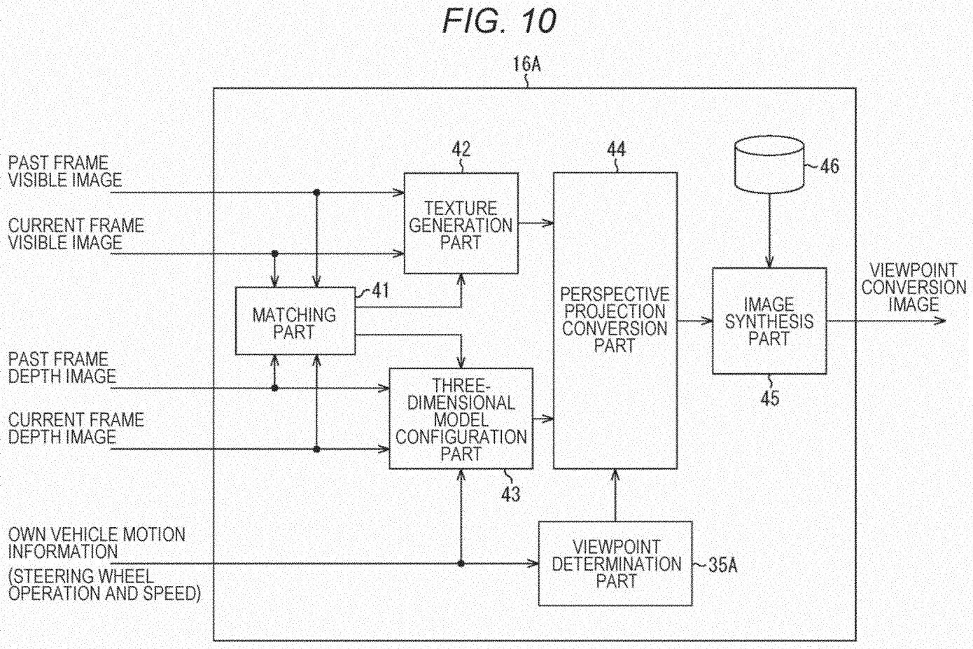

FIG. 10 is a block diagram showing a second configuration example of the viewpoint conversion image generation part 16.

As shown in FIG. 10, the viewpoint conversion image generation part 16A includes a viewpoint determination part 35A, a matching part 41, a texture generation part 42, a three-dimensional model configuration part 43, a perspective projection conversion part 44, an image synthesis part 45, and a storage part 46.

The steering wheel operation and the speed of the vehicle 21 and the like are supplied to the viewpoint determination part 35A from an ECU (not shown) as own vehicle motion information. Then, the viewpoint determination part 35A uses the own vehicle motion information to determine a viewpoint at the time of generating a viewpoint conversion image of a view from the viewpoint so that the viewpoint is of the viewpoint position and the line-of-sight direction according to the speed of the vehicle 21, and supplies information indicating the viewpoint to the perspective projection conversion part 44. Note that the detailed configuration of the viewpoint determination part 35A will be described later with reference to FIG. 12.

The matching part 41 performs matching of a plurality of corresponding points set on the surface of an object around the vehicle 21 using the current frame visible image, the past frame visible image, the current frame depth image, and the past frame depth image.

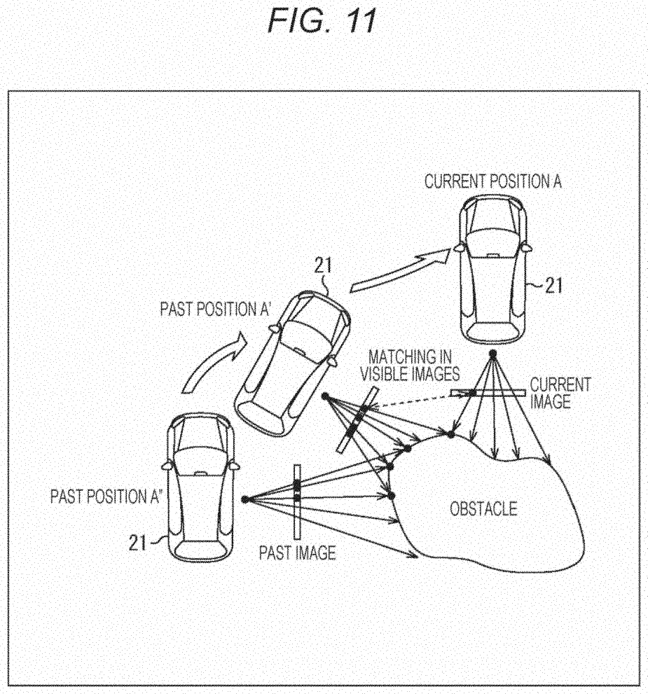

For example, as shown in FIG. 11, the matching part 41 can match corresponding points that are the same on the surface of an obstacle in the past image acquired at a plurality of past positions (a past frame visible image or a past frame depth image) and the current image acquired at a current position (the current frame visible image or the current frame depth image).

The texture generation part 42 stitches the current frame visible image and the past frame visible image so as to match the corresponding points thereof on the basis of the matching result of the visible images supplied from the matching part 41. Then, the texture generation part 42 generates a texture for expressing the surface and texture of the object around the vehicle 21 from the visible image acquired by stitching, and supplies the texture to the perspective projection conversion part 44.

The three-dimensional model configuration part 43 stitches the current frame depth image and the past frame depth image so as to match the corresponding points thereof on the basis of the matching result of the depth images supplied from the matching part 41. Then, the three-dimensional model configuration part 43 forms a three-dimensional model for three-dimensionally expressing an object around the vehicle 21 from the depth image acquired by the stitching and supplies the three-dimensional model to the perspective projection conversion part 44.

The perspective projection conversion part 44 applies the texture supplied from the texture generation part 42 to the three-dimensional model supplied from the three-dimensional model configuration part 43, creates a perspective projection image of the three-dimensional model attached with the texture viewed from the viewpoint determined by the viewpoint determination part 35A, and supplies the perspective projection image to the image synthesis part 45. For example, the perspective projection conversion part 44 can create a viewpoint conversion image using a perspective projection conversion matrix represented by the following Equation (1). Here, Equation (1) represents perspective projection from an arbitrary point x_{V} to the simultaneous coordinate expression y₀ of the projection point x₀ when the viewpoint x_{V3}=−d and the projection plane x_{V3=0}, and for example, when d is infinite, parallel projection is established.

$$[ Math . 1 ]$$

$$( \begin{matrix}{y}_{01} \\ {y}_{02} \\ {y}_{03} \\ {w}_{0}\end{matrix} ) = ( \begin{matrix}1 & 0 & 0 & 0 \\ 0 & 1 & 0 & 0 \\ 0 & 0 & 0 & 0 \\ 0 & 0 & 1 \text{/} d & 1\end{matrix} ) ( \begin{matrix}{x}_{V 1} \\ {x}_{V 2} \\ {x}_{V 3} \\ 1\end{matrix} ) \qquad ( 1 )$$

The image synthesis part 45 reads the illustrative image of the vehicle 21 from the storage part 46 and synthesizes the illustrative image of the vehicle 21 according to the current position of the vehicle 21 in the perspective projection image supplied from the perspective projection conversion part 44. Therefore, the image synthesis part 45 can acquire the viewpoint conversion image as described above with reference to FIGS. 3 to 7, and outputs the viewpoint conversion image to, for example, a subsequent display device (not shown).

The storage part 46 stores, as advance information, data of the illustrative image of the vehicle 21 (image data that is of an image related to the vehicle 21 and is of the vehicle 21 viewed from each viewpoint).

As described above, the viewpoint conversion image generation part 16A can generate the viewpoint conversion image in which the viewpoint is set according to the speed of the vehicle 21. At this time, the viewpoint conversion image generation part 16A can generate a viewpoint conversion image in which a degree of freedom is higher and blind spots is reliably reduced by using a three-dimensional model.

<Configuration Example of Viewpoint Determination Part>

With reference to FIGS. 12 to 16, a configuration example of the viewpoint determination part 35A and an example of processing performed by the viewpoint determination part 35A will be described. Note that, in the following, the viewpoint determination part 35A will be described. For example, after calculating the speed of the vehicle 21 from the motion vector in the viewpoint determination part 35 of FIG. 8, similar processing to that of the viewpoint determination part 35A is performed using the speed.

As shown in FIG. 12, the viewpoint determination part 35A includes a parameter calculation part 51, a 0 lookup table storage part 52, an r lookup table storage part 53, a viewpoint coordinate calculation part 54, an origin coordinate correction part 55, an X lookup table storage part 56, and a corrected viewpoint coordinate calculation part 57.

Here, as shown in FIG. 13, the angle parameter θ used in the viewpoint determination part 35A indicates an angle formed by the direction of the viewpoint with respect to a vertical line passing through the center of the vehicle 21. Similarly, the distance parameter r indicates the distance from the center of the vehicle 21 to the viewpoint, and the inclination parameter (p indicates the angle at which the viewpoint is inclined with respect to the traveling direction of the vehicle 21. Furthermore, the vehicle speed is defined as plus in the traveling direction of the vehicle 21 and minus in the direction opposite to the traveling direction.

The parameter calculation part 51 calculates the parameter r indicating a distance from the center of the vehicle 21 to the viewpoint, and the parameter θ indicating the angle formed by the viewpoint directions with respect to the vertical line passing through the center of the vehicle 21 according to the vehicle speed indicated by the own vehicle motion information as described above, and supplies the parameters to the viewpoint coordinate calculation part 54.

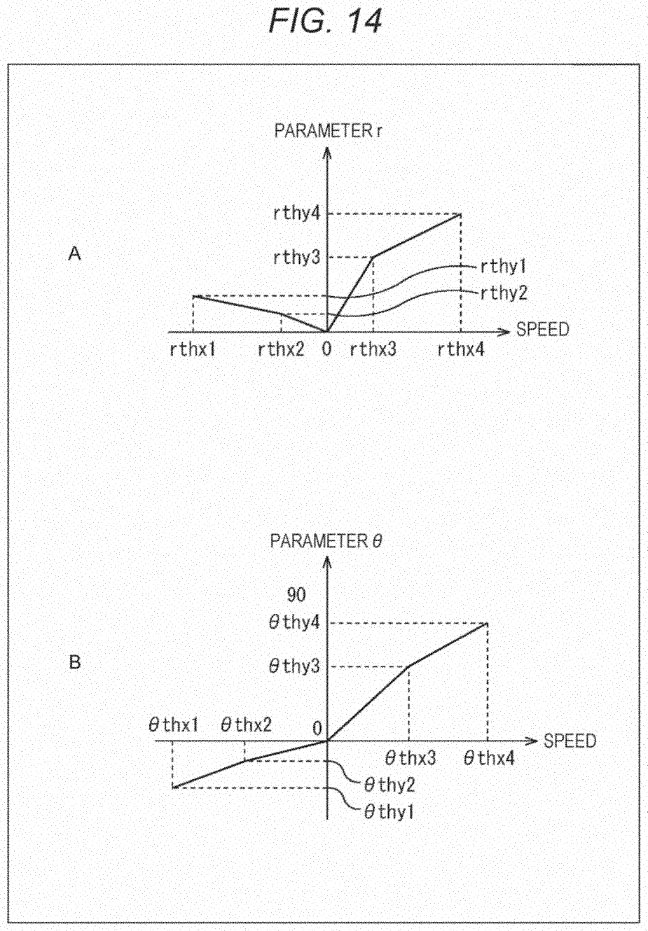

For example, the parameter calculation part 51 can determine the parameter r on the basis of the relationship between the speed and the parameter r as shown in A of FIG. 14. In the example shown in A of FIG. 14, the parameter r changes so as to decrease linearly from a first parameter threshold rthy1 to a second parameter threshold rthy2 from a first speed threshold rthx1 to a second speed threshold rthx2. Furthermore, the parameter r changes so as to decrease linearly from the second parameter threshold rthy2 to 0 from the second speed threshold rthx2 to the speed 0, and changes so as to increase linearly from 0 to a third parameter threshold rthy3 from the speed 0 to a third speed threshold rthx3. Similarly, the parameter r changes so as to increase linearly from the third parameter threshold rthy3 to a fourth parameter threshold rthy4 from the third speed threshold rthx3 to a fourth speed threshold rthx4. As described above, the parameter r is set so that the decrease rate or the increase rate with respect to the speed changes in two steps in the plus direction and the minus direction of the speed vector, respectively, and set so that each inclination is an appropriate distance.

Similarly, the parameter calculation part 51 can determine the parameter θ on the basis of the relationship between the speed and the parameter θ as shown in B of FIG. 14. In the example shown in B of FIG. 14, the parameter θ changes so as to increase linearly from a first parameter threshold θthy1 to a second parameter threshold θthy2 from a first speed threshold θthx1 to a second speed threshold θthx2. Furthermore, the parameter θ changes so as to increase linearly from the second parameter threshold θthy2 to 0 from the second speed threshold θthx2 to the speed 0, and changes so as to increase linearly from 0 to a third parameter threshold θthy3 from the speed 0 to a third speed threshold θthx3. Similarly, the parameter θ changes so as to increase linearly from the third parameter threshold θthy3 to a fourth parameter threshold θthy4 from the third speed threshold θthx3 to a fourth speed threshold θthx4. As described above, the parameter θ is set so that the increase rate with respect to the speed changes in two steps in the plus direction and the minus direction of the speed vector, respectively, and set so that each inclination is an appropriate angle.

The θ lookup table storage part 52 stores a relationship as shown in B of FIG. 14 as a lookup table that is referred to when the parameter calculation part 51 determines the parameter θ.

The r lookup table storage part 53 stores a relationship as shown in A of FIG. 14 as a lookup table of the parameter r that is referred to when the parameter calculation part 51 determines the parameter r.

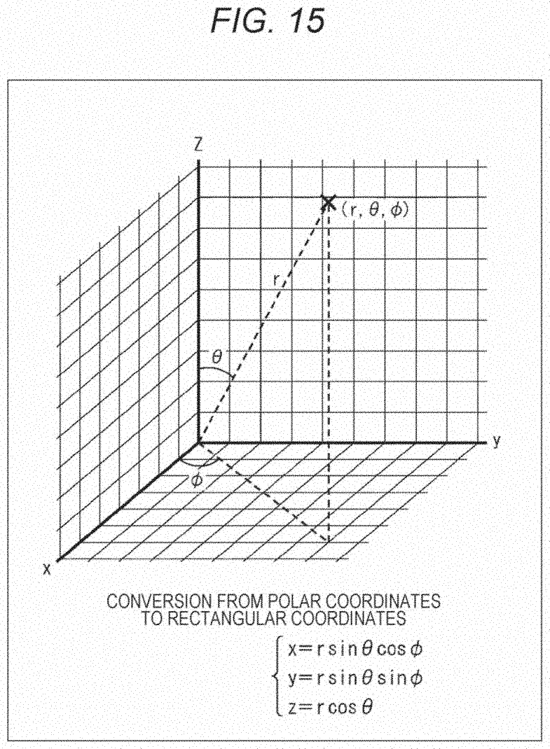

The viewpoint coordinate calculation part 54 uses the parameter r and the parameter C supplied from the parameter calculation part 51 and the parameter φ (for example, information indicating steering wheel operation) indicated by the own vehicle motion information as described above to calculate the viewpoint coordinates and supplies the viewpoint coordinates to the corrected viewpoint coordinate calculation part 57. For example, as shown in FIG. 15, the viewpoint coordinate calculation part 54 uses a formula for converting polar coordinates to rectangular coordinates to calculate the viewpoint coordinates (x₀, y₀, z₀) when the own vehicle is the center. Note that, as the parameter φ, a value set by a driver, a developer, or the like may be used.

The origin coordinate correction part 55 calculates an origin correction vector Xdiff indicating the direction and magnitude of the origin correction amount for moving the origin from the center of the vehicle 21 according to the vehicle speed indicated by the own vehicle motion information as described above, and supplies the origin correction vector Xdiff to the corrected viewpoint coordinate calculation part 57.

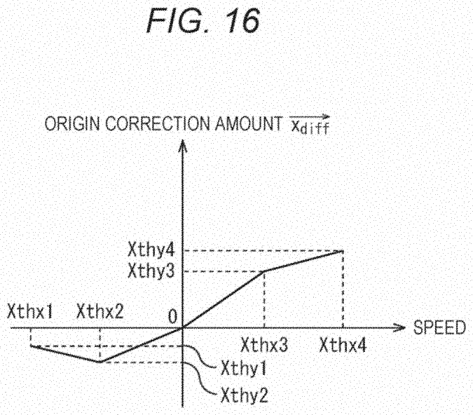

For example, the origin coordinate correction part 55 can determine the origin correction vector Xdiff on the basis of the relationship between the speed and the origin correction vector Xdiff as shown in FIG. 16. In the example shown in FIG. 16, the origin correction vector Xdiff changes so as to decrease linearly from a first parameter threshold Xthy1 to a second parameter threshold Xthy2 from a first speed threshold Xthx1 to a second speed threshold Xthx2. Furthermore, the origin correction vector Xdiff changes so as to increase linearly from the second parameter threshold Xthy2 to 0 from the second speed threshold Xthx2 to the speed 0, and changes so as to increase linearly from 0 to a third parameter threshold Xthy3 from the speed 0 to a third speed threshold Xthx3. Similarly, the origin correction vector Xdiff changes so as to increase linearly from a third parameter threshold Xthy3 to a fourth parameter threshold Xthy4 from a third speed threshold Xthx3 to a fourth speed threshold Xthx4. As described above, the origin correction vector Xdiff is set so that the decrease rate or the increase rate with respect to the speed changes in two steps in the plus direction and the minus direction of the speed vector, respectively, and set so that each inclination is an appropriate correction amount.

The X lookup table storage part 56 stores a relationship as shown in FIG. 16 as a lookup table that is referred to when the origin coordinate correction part 55 determines the origin correction vector Xdiff.

The corrected viewpoint coordinate calculation part 57 performs a correction according to the origin correction vector Xdiff on the viewpoint coordinates (x₀, y₀, z₀) when the own vehicle supplied from the viewpoint coordinate calculation part 54 is used as a center to move the origin, and calculates the corrected viewpoint coordinates. Then, the corrected viewpoint coordinate calculation part 57 outputs the calculated viewpoint coordinates as final viewpoint coordinates (x, y, z), and supplies the final viewpoint coordinates to, for example, the perspective projection conversion part 44 in FIG. 10.

The viewpoint determination part 35A is configured as described above, and can determine an appropriate viewpoint according to the speed of the vehicle 21.

Furthermore, by correcting the origin coordinates in the viewpoint determination part 35A, that is, by adjusting the x-coordinate of the viewpoint origin according to the speed vector of the vehicle 21, for example, as described with reference to FIG. 7 described above, it is possible to determine a viewpoint that makes it easier to recognize an obstacle at the rear of the vehicle 21.

<Processing Example of Image Processing>

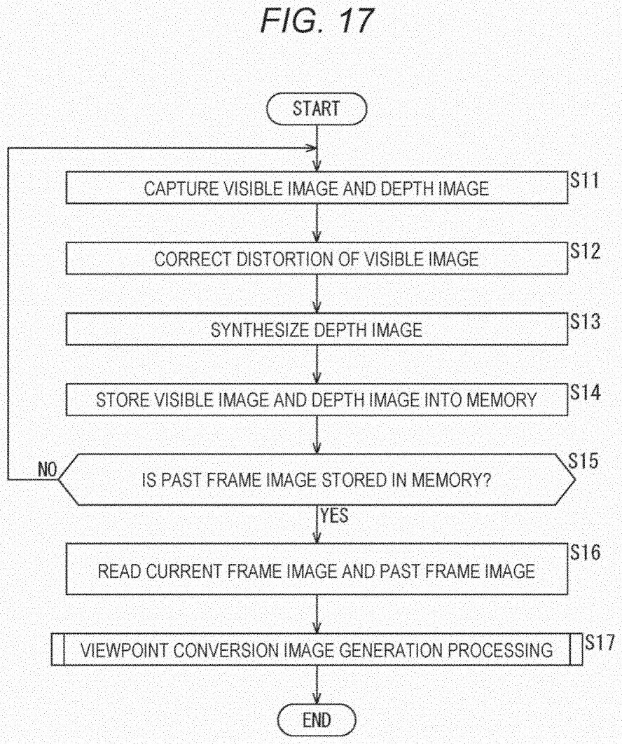

The image processing performed in the image processing device 11 will be described with reference to FIGS. 17 to 19.

FIG. 17 is a flowchart for explaining image processing performed in the image processing device 11.

For example, when the image processing device 11 is supplied with power and activated, processing starts and the image processing device 11 acquires a visible image and a depth image captured by the RGB camera 23 and the distance sensor 24 in FIG. 20.

In step S12, the distortion correction part 12 corrects the distortion occurring in the visible image captured at a wide angle, and supplies the resultant to the visible image memory 13, the depth image synthesis part 14, and the viewpoint conversion image generation part 16.

In step S13, the depth image synthesis part 14 synthesizes the depth image so as to improve the resolution of the low-resolution depth image by using the visible image supplied from the distortion correction part 12 in step S12 as a guide signal, and supplies the synthesized image to the depth image memory 15 and the viewpoint conversion image generation part 16.

In step S14, the visible image memory 13 stores the visible image supplied from the distortion correction part 12 in step S12, and the depth image memory 15 stores the depth image supplied from the depth image synthesis part 14 in step S13.

In step S15, the viewpoint conversion image generation part 16 determines whether or not the past frame image required for the processing is stored in the memory, that is, whether or not the past frame visible image is stored in the visible image memory 13, and the past frame depth image is stored in the depth image memory 15. Then, the processing of steps S11 to S15 is repeatedly performed until the viewpoint conversion image generation part 16 determines that the past frame image required for the processing is stored in the memory.

In step S15, in a case where the viewpoint conversion image generation part 16 determines that the past frame image is stored in the memory, the process proceeds to step S16. In step S16, the viewpoint conversion image generation part 16 reads the current frame visible image supplied from the distortion correction part 12 in the immediately preceding step S12, and the current frame depth image supplied from the depth image synthesis part 14 in the immediately preceding step S13.

Furthermore, at this time, the viewpoint conversion image generation part 16 reads the past frame visible image from the visible image memory 13 and reads the past frame depth image from the depth image memory 15.

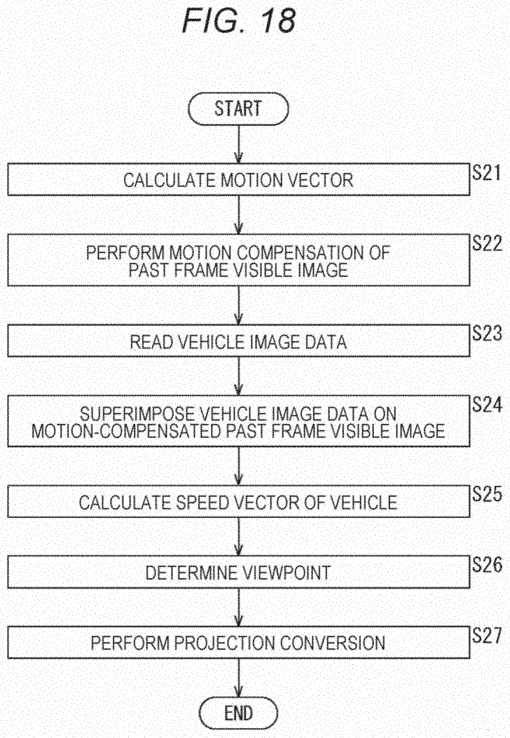

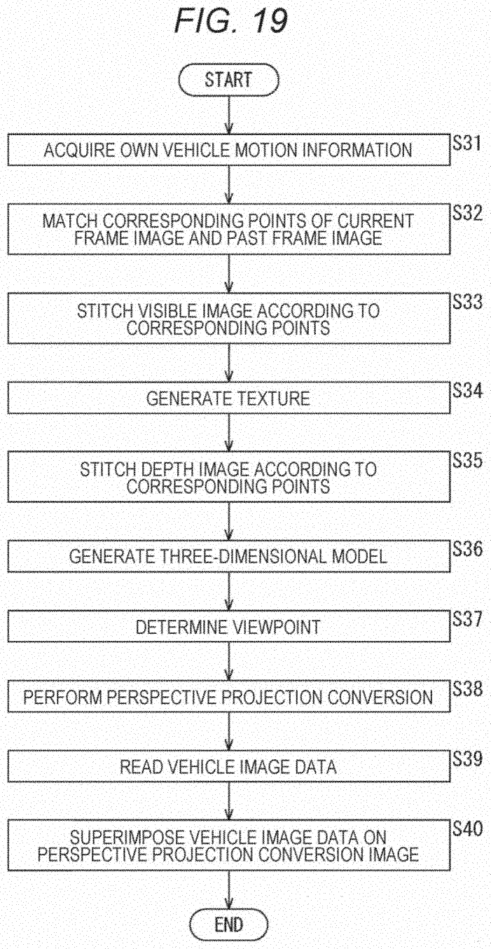

In step S17, the viewpoint conversion image generation part 16 uses the current frame visible image, the current frame depth image, the past frame visible image, and the past frame depth image read in step S16 to perform viewpoint conversion image generation processing (processing of FIG. 18 or FIG. 19) of generating a viewpoint conversion image.

FIG. 18 is a flowchart for explaining a first processing example of viewpoint conversion image generation processing performed by the viewpoint conversion image generation part 16 of FIG. 8.

In step S21, the motion estimation part 31 uses the current frame visible image and the past frame visible image, as well as the current frame depth image and the past frame depth image to calculate the motion vector of the moving object, and supplies the motion vector to the motion compensation part 32 and the viewpoint determination part 35.

In step S22, the motion compensation part 32 performs motion compensation on the past frame visible image on the basis of the motion vector of the moving object supplied in step S21, and supplies the motion-compensated past frame visible image to the image synthesis part 33.

In step S23, the image synthesis part 33 reads the data of the illustrative image of the vehicle 21 from the storage part 34.

In step S24, the image synthesis part 33 superimposes the illustrative image of the vehicle 21 read in step S23 on the motion-compensated past frame visible image supplied from the motion compensation part 32 in step S22, and supplies the image synthesizing result obtained as a result thereof to the projection conversion part 36.

In step S25, the viewpoint determination part 35 calculates the speed vector of the vehicle 21 on the basis of the motion vector of the moving object supplied from the motion estimation part 31 in step S21.

In step S26, the viewpoint determination part 35 determines the viewpoint at the time of generating the viewpoint conversion image such that the viewpoint position and the line-of-sight direction correspond to the speed vector of the vehicle 21 calculated in step S25.

In step S27, the projection conversion part 36 performs projection conversion on the image synthesizing result supplied from the image synthesis part 33 in step S24 so that the image is a view from the viewpoint determined by the viewpoint determination part 35 in step S26. Therefore, the projection conversion part 36 generates the viewpoint conversion image and outputs the viewpoint conversion image to, for example, a display device (not shown) at the subsequent stage, and then the viewpoint conversion image generation processing ends.

FIG. 19 is a flowchart for explaining a second processing example of the viewpoint conversion image generation processing performed by the viewpoint conversion image generation part 16A of FIG. 10.

In step S31, the viewpoint determination part 35A and the three-dimensional model configuration part 43 acquire the own vehicle motion information at the current point.

In step S32, the matching part 41 matches the corresponding points between the current frame visible image and the past frame visible image, and also matches the corresponding points between the current frame depth image and the past frame depth image.

In step S33, the texture generation part 42 stitches the current frame visible image and the past frame visible image according to the corresponding points of the images that have been matched by the matching part 41 in step S32.

In step S34, the texture generation part 42 generates a texture from the visible image acquired by stitching in step S33, and supplies the texture to the perspective projection conversion part 44.

In step S35, the three-dimensional model configuration part 43 stitches the current frame depth image and the past frame depth image so as to match the corresponding points of the images that have been matched by the matching part 41 in step S32.

In step S36, the three-dimensional model configuration part 43 generates a three-dimensional model formed on the basis of the depth image acquired by stitching in step S35, and supplies the three-dimensional model to the perspective projection conversion part 44.

In step S37, the viewpoint determination part 35A uses the own vehicle motion information acquired in step S31 to determine the viewpoint at the time of generating the viewpoint conversion image such that the viewpoint position and the line-of-sight direction correspond to the speed of the vehicle 21.

In step S38, the perspective projection conversion part 44 attaches the texture supplied from the texture generation part 42 in step S34 to the three-dimensional model supplied from the three-dimensional model configuration part 43 in step S36. Then, the perspective projection conversion part 44 performs perspective projection conversion for creating a perspective projection image of the three-dimensional model attached with the texture viewed from the viewpoint determined by the viewpoint determination part 35A in step S37, and supplies the perspective projection image to the image synthesis part 45.

In step S39, the image synthesis part 45 reads the data of the illustrative image of the vehicle 21 from the storage part 46.

In step S40, the image synthesis part 45 superimposes the illustrative image of the vehicle 21 read in step S39 on the perspective projection image supplied from the perspective projection conversion part 44 in step S38. Therefore, the image synthesis part 45 generates the viewpoint conversion image and outputs the viewpoint conversion image to, for example, a display device (not shown) at the subsequent stage, and then the viewpoint conversion image generation processing ends.

As described above, the image processing device 11 can change the viewpoint according to the speed of the vehicle 21 to create a viewpoint conversion image that makes it easier to grasp the surrounding situation, and can present the viewpoint conversion image to the driver. In particular, the image processing device 11 calculates the speed of the vehicle 21 from the past frame to achieve the processing with low delay without requiring the processing of the ECU, for example. Moreover, the image processing device 11 can grasp the shape of the peripheral object by using the past frame, and can reduce the blind spot of the viewpoint conversion image.

<Vehicle Configuration Example>

With reference to FIG. 20, a configuration example of the vehicle 21 equipped with the image processing device 11 will be described.

As shown in FIG. 20, the vehicle 21 includes, for example, four RGB cameras 23-1 to 23-4 and four distance sensors 24-1 to 24-4. For example, the RGB camera 23 includes a complementary metal oxide semiconductor (CMOS) image sensor, and supplies a wide-angle and high-resolution visible image to the image processing device 11. Furthermore, the distance sensor 24 includes, for example, a light detection and ranging (LiDAR), a millimeter wave radar, or the like, and supplies a narrow-angle and low-resolution depth image to the image processing device 11.

In the configuration example shown in FIG. 20, the RGB camera 23-1 and the distance sensor 24-1 are arranged in front of the vehicle 21, and the RGB camera 23-1 captures the front of the vehicle 21 as shown by a broken line at a wide angle, and the distance sensor 24-1 senses a narrower range. Similarly, the RGB camera 23-2 and the distance sensor 24-2 are arranged in rear of the vehicle 21, and the RGB camera 23-2 captures the rear of the vehicle 21 as shown by a broken line at a wide angle, and the distance sensor 24-2 senses a narrower range.

Furthermore, the RGB camera 23-3 and the distance sensor 24-3 are arranged in the right side of the vehicle 21, and the RGB camera 23-3 captures the right side of the vehicle 21 as shown by a broken line at a wide angle, and the distance sensor 24-3 senses a narrower range. Similarly, the RGB camera 23-4 and the distance sensor 24-4 are arranged in the left side of the vehicle 21, and the RGB camera 23-4 captures the left side of the vehicle 21 as shown by a broken line at a wide angle, and the distance sensor 24-4 senses a narrower range.

Note that the present technology can be applied to various mobile devices such as, for example, a wirelessly controlled robot and a small flying device (a so-called drone) other than the vehicle 21.

<Computer Configuration Example>

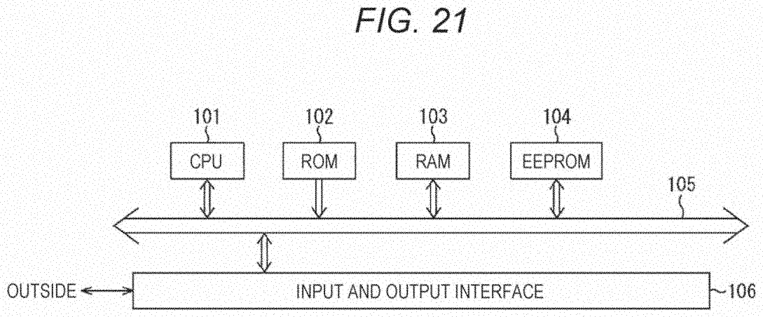

FIG. 21 is a block diagram showing a configuration example of a hardware configuration of a computer that executes the above-described series of processing by a program.

In the computer, a central processing unit (CPU) 101, a read only memory (ROM) 102, a random access memory (RAM) 103, and an electronically erasable and programmable read only memory (EEPROM) 104 are interconnected by a bus 105. An input and output interface 106 is further connected to the bus 105, and the input and output interface 106 is connected to the outside.

In the computer configured as described above, for example, the CPU 101 loads the program stored in the ROM 102 and the EEPROM 104 into the RAM 103 via the bus 105, and executes the program, so that the above-described series of processing is performed. Furthermore, the program executed by the computer (CPU 101) can be written in the ROM 102 in advance, or can be externally installed or updated in the EEPROM 104 via the input and output interface 106.

<<Application Examples>>

The technology according to the present disclosure can be applied to various products. For example, the technology according to the present disclosure may be realized as a device mounted on any type of mobile body such as an automobile, electric vehicle, hybrid electric vehicle, motorcycle, bicycle, personal mobility, airplane, drone, ship, robot, construction machine, or agricultural machine (tractor).

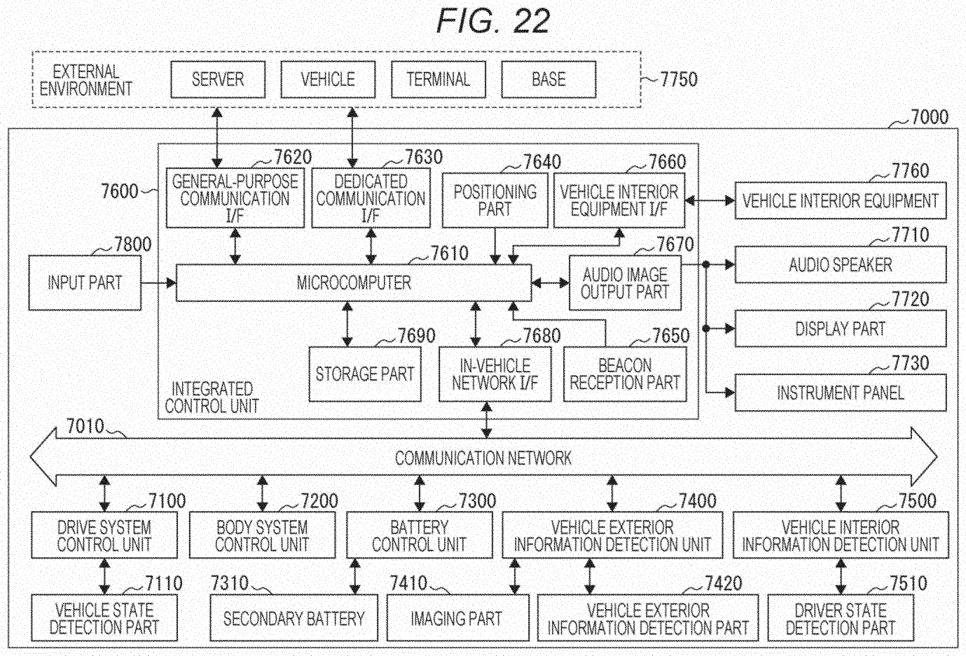

FIG. 22 is a block diagram showing a schematic configuration example of a vehicle control system 7000 which is an example of a mobile body control system to which the technology according to the present disclosure can be applied. The vehicle control system 7000 includes a plurality of electronic control units connected via a communication network 7010. In the example shown in FIG. 22, the vehicle control system 7000 includes a drive system control unit 7100, a body system control unit 7200, a battery control unit 7300, a vehicle exterior information detection unit 7400, a vehicle interior information detection unit 7500, and an integrated control unit 7600. The communication network 7010 connecting the plurality of control units may be, for example, an in-vehicle communication network conforming to an arbitrary standard such as the controller area network (CAN), the local interconnect network (LIN), the local area network (LAN), or the FlexRay (registered trademark).

Each control unit includes a microcomputer that performs operation processing according to various programs, a storage part that stores programs executed by the microcomputer, parameters used for various operations, or the like, and a drive circuit that drives devices subjected to various control. Each control unit includes a network I/F for communicating with another control unit via the communication network 7010, and includes a communication I/F for communication by wired communication or wireless communication with vehicle interior or exterior device, a sensor, or the like. FIG. 22 shows, as functional configuration of the integrated control unit 7600, a microcomputer 7610, a general-purpose communication I/F 7620, a dedicated communication I/F 7630, a positioning part 7640, a beacon reception part 7650, vehicle interior equipment I/F 7660, an audio image output part 7670, an in-vehicle network I/F 7680, and a storage part 7690. Similarly, each of the other control units includes a microcomputer, a communication I/F, a storage part, and the like.

The drive system control unit 7100 controls the operation of the device related to the drive system of the vehicle according to various programs. For example, the drive system control unit 7100 functions as a control device of a driving force generation device for generating a drive force of a vehicle such as an internal combustion engine or a driving motor, a drive force transmission mechanism for transmitting a drive force to wheels, a steering mechanism that adjusts a wheeling angle of the vehicle, a braking device that generates a braking force of the vehicle, and the like. The drive system control unit 7100 may have a function as a control device such as antilock brake system (ABS), or an electronic stability control (ESC).

A vehicle state detection part 7110 is connected to the drive system control unit 7100. The vehicle state detection part 7110 includes, for example, at least one of a gyro sensor that detects the angular velocity of the axis rotational motion of the vehicle body, an acceleration sensor that detects the acceleration of the vehicle, or a sensor for detecting an operation amount of an accelerator pedal, an operation amount of a brake pedal, steering of a steering wheel, an engine rotation speed, a wheel rotation speed, or the like. The drive system control unit 7100 performs operation processing using the signal input from the vehicle state detection part 7110 and controls the internal combustion engine, the driving motor, the electric power steering device, the brake device, or the like.

The body system control unit 7200 controls the operation of various devices mounted on the vehicle according to various programs. For example, the body system control unit 7200 functions as a keyless entry system, a smart key system, a power window device, or a control device for various lamps such as a head lamp, a back lamp, a brake lamp, a turn indicator, or a fog lamp. In this case, radio waves transmitted from a portable device that substitutes keys or signals of various switches may be input to the body system control unit 7200. The body system control unit 7200 receives input of these radio waves or signals and controls a door lock device, a power window device, a lamp, or the like of the vehicle.

The battery control unit 7300 controls a secondary battery 7310 that is a power supply source of the driving motor according to various programs. For example, information such as battery temperature, a battery output voltage, or remaining capacity of the battery is input to the battery control unit 7300 from the battery device including the secondary battery 7310. The battery control unit 7300 performs arithmetic processing using these signals and controls the temperature adjustment of the secondary battery 7310, or the cooling device or the like included in the battery device.

The vehicle exterior information detection unit 7400 detects information outside the vehicle equipped with the vehicle control system 7000. For example, at least one of the imaging part 7410 or the vehicle exterior information detection part 7420 is connected to the vehicle exterior information detection unit 7400. The imaging part 7410 includes at least one of a time of flight (ToF) camera, a stereo camera, a monocular camera, an infrared camera, or other cameras. The vehicle exterior information detection part 7420 includes, for example, at least one of an environmental sensor for detecting the current weather or climate, or an ambient information detection sensor for detecting another vehicle, an obstacle, a pedestrian, or the like around the vehicle equipped with the vehicle control system 7000.

The environmental sensor may be, for example, at least one of a raindrop sensor that detects rain, a fog sensor that detects mist, a sunshine sensor that detects sunshine degree, or a snow sensor that detects snowfall. The ambient information detection sensor may be at least one of an ultrasonic sensor, a radar device, or a light detection and ranging, laser imaging detection and ranging (LIDAR) device. The imaging part 7410 and the vehicle exterior information detection part 7420 may be provided as independent sensors or devices, respectively, or may be provided as a device in which a plurality of sensors or devices are integrated.

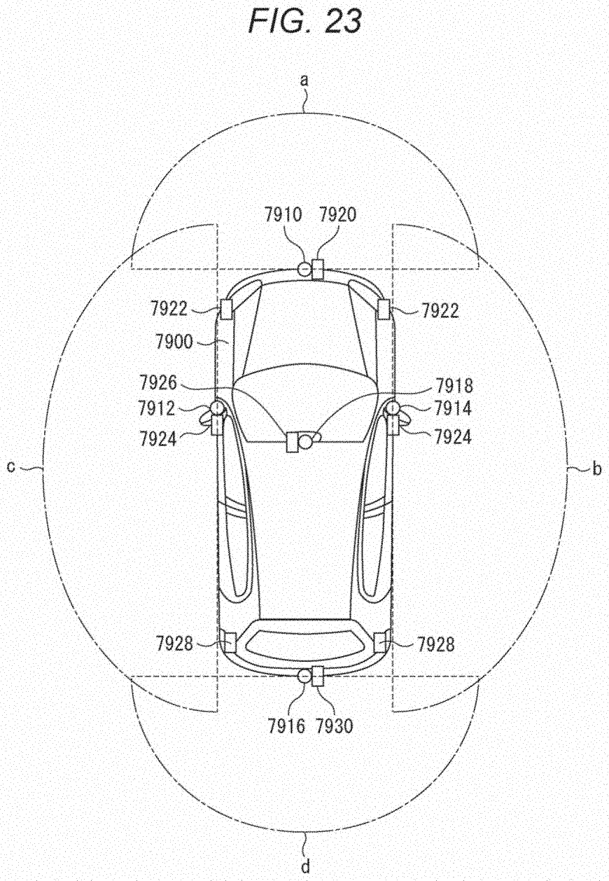

Here, FIG. 23 shows an example of installation positions of the imaging part 7410 and the vehicle exterior information detection part 7420. Imaging parts 7910, 7912, 7914, 7916, and 7918 are provided at, for example, at least one of a front nose, a side mirror, a rear bumper, or a back door of the vehicle 7900, or an upper portion of a windshield in the vehicle compartment. The imaging part 7910 provided in the front nose and the imaging part 7918 provided in the upper portion of the windshield in the vehicle compartment mainly acquire an image ahead of the vehicle 7900. The imaging parts 7912 and 7914 provided in the side mirror mainly acquire an image of the side of the vehicle 7900. The imaging part 7916 provided in the rear bumper or the back door mainly acquires an image behind the vehicle 7900. The imaging part 7918 provided on the upper portion of the windshield in the vehicle compartment is mainly used for detecting a preceding vehicle, a pedestrian, an obstacle, a traffic signal, a traffic sign, a lane, or the like.

Note that FIG. 23 shows an example of the imaging range of each of the imaging parts 7910, 7912, 7914, and 7916. An imaging range a indicates the imaging range of the imaging part 7910 provided in the front nose, imaging ranges b and c indicate the imaging ranges of the imaging parts 7912 and 7914 provided in the side mirror, respectively, and an imaging range d indicates the imaging range of the imaging part 7916 provided in the rear bumper or the back door. For example, by superimposing the image data imaged by the imaging parts 7910, 7912, 7914, and 7916, an overhead view image of the vehicle 7900 viewed from above is obtained.

The vehicle exterior information detection parts 7920, 7922, 7924, 7926, 7928, and 7930 provided on the front, rear, side, or corner of the vehicle 7900 and the windshield in the upper portion of the vehicle compartment may be ultrasonic sensors or radar devices, for example. The vehicle exterior information detection parts 7920, 7926, and 7930 provided at the front nose, the rear bumper, or the back door of the vehicle 7900, and the upper portion of the windshield of the vehicle compartment may be the LIDAR device, for example. These vehicle exterior information detection parts 7920 to 7930 are mainly used for detecting a preceding vehicle, a pedestrian, an obstacle, or the like.

Returning to FIG. 22, the description will be continued. The vehicle exterior information detection unit 7400 causes the imaging part 7410 to image an image of the exterior of the vehicle and receives the imaged image data. Furthermore, the vehicle exterior information detection unit 7400 receives the detection information from the connected vehicle exterior information detection part 7420. In a case where the vehicle exterior information detection part 7420 is an ultrasonic sensor, a radar device, or a LIDAR device, the vehicle exterior information detection unit 7400 transmits ultrasonic waves, electromagnetic waves, or the like, and receives information of the received reflected waves. The vehicle exterior information detection unit 7400 may perform object detection processing of a person, a car, an obstacle, a sign, a character on a road surface, or the like, or distance detection processing on the basis of the received information. The vehicle exterior information detection unit 7400 may perform environment recognition processing for recognizing rainfall, fog, road surface condition, or the like on the basis of the received information. The vehicle exterior information detection unit 7400 may calculate the distance to the object outside the vehicle on the basis of the received information.

Furthermore, the vehicle exterior information detection unit 7400 may perform image recognition processing of recognizing a person, a car, an obstacle, a sign, a character on a road surface, or the like, or distance detection processing, on the basis of the received image data. The vehicle exterior information detection unit 7400 performs processing such as distortion correction or positioning on the received image data and synthesizes the image data imaged by different imaging parts 7410 to generate an overhead view image or a panorama image. The vehicle exterior information detection unit 7400 may perform viewpoint conversion processing using image data imaged by different imaging parts 7410.

The vehicle interior information detection unit 7500 detects vehicle interior information. For example, a driver state detection part 7510 that detects the state of the driver is connected to the vehicle interior information detection unit 7500. The driver state detection part 7510 may include a camera for imaging the driver, a biometric sensor for detecting the biological information of the driver, a microphone for collecting sound in the vehicle compartment, and the like. The biometric sensor is provided on, for example, a seating surface, a steering wheel, or the like, and detects biometric information of an occupant sitting on a seat or a driver holding a steering wheel. The vehicle interior information detection unit 7500 may calculate the degree of fatigue or the degree of concentration of the driver on the basis of the detection information input from the driver state detection part 7510, and may determine whether or not the driver is sleeping. The vehicle interior information detection unit 7500 may perform processing such as noise canceling processing on the collected sound signal.

The integrated control unit 7600 controls the overall operation of the vehicle control system 7000 according to various programs. An input part 7800 is connected to the integrated control unit 7600. The input part 7800 is realized by a device such as a touch panel, a button, a microphone, a switch, or a lever that can be input operated by an occupant, for example. Data obtained by performing speech recognition on the sound input by the microphone may be input to the integrated control unit 7600. The input part 7800 may be, for example, a remote control device using infrared rays or other radio waves, or an external connection device such as a mobile phone or a personal digital assistant (PDA) corresponding to the operation of the vehicle control system 7000. The input part 7800 may be, for example, a camera, in which case the occupant can input information by gesture. Alternatively, data obtained by detecting the movement of the wearable device worn by the occupant may be input. Moreover, the input part 7800 may include, for example, an input control circuit or the like that generates an input signal on the basis of information input by an occupant or the like using the input part 7800 and outputs the input signal to the integrated control unit 7600. By operating the input part 7800, an occupant or the like inputs various data or gives an instruction on processing operation to the vehicle control system 7000.

The storage part 7690 may include a read only memory (ROM) that stores various programs to be executed by the microcomputer, and a random access memory (RAM) that stores various parameters, operation results, sensor values, or the like. Furthermore, the storage part 7690 may be realized by a magnetic storage device such as a hard disc drive (HDD), a semiconductor storage device, an optical storage device, a magneto-optical storage device, or the like.

The general-purpose communication I/F 7620 is a general-purpose communication I/F that mediates communication with various devices existing in an external environment 7750. A cellular communication protocol such as global system of mobile communications (GSM) (registered trademark), WiMAX (registered trademark), long term evolution (LTE (registered trademark)), or LTE-advanced (LTE-A), or other wireless communication protocols such as a wireless LAN (Wi-Fi (registered trademark)), or Bluetooth (registered trademark), may be implemented in the general-purpose communication I/F 7620. The general-purpose communication I/F 7620 may be connected to a device (for example, an application server or a control server) existing on an external network (for example, the Internet, a cloud network, or a company specific network) via a base station or an access point, for example. Furthermore, the general-purpose communication I/F 7620 uses, for example, the peer to peer (P2P) technology and may be connected with a terminal existing in the vicinity of the vehicle (for example, a terminal of a driver, a pedestrian, or a shop, or the machine type communication terminal (MTC).

The dedicated communication I/F 7630 is a communication I/F supporting a communication protocol formulated for use in a vehicle. For example, in the dedicated communication I/F 7630, a standard protocol such as the wireless access in vehicle environment (WAVE) that is combination of lower layer IEEE 802.11p and upper layer IEEE 1609, the dedicated short range communications (DSRC), or the cellular communication protocol may be implemented. Typically, the dedicated communication I/F 7630 performs V2X communication that is concept including one or more of a vehicle to vehicle communication, a vehicle to infrastructure communication, a vehicle to home communication, and a vehicle to pedestrian communication.

The positioning part 7640 receives, for example, a global navigation satellite system (GNSS) signal from a GNSS satellite (for example, a GPS signal from a global positioning system (GPS) satellite) and performs positioning, to generate position information including the latitude, longitude, and altitude of the vehicle. Note that the positioning part 7640 may specify the current position by exchanging signals with the wireless access point or may acquire the position information from a terminal such as a mobile phone, a PHS, or a smartphone having a positioning function.

The beacon reception part 7650 receives, for example, radio waves or electromagnetic waves transmitted from a radio station or the like installed on the road, and acquires information such as the current position, congestion, road closure, or required time. Note that the function of the beacon reception part 7650 may be included in the dedicated communication I/F 7630 described above.

The vehicle interior equipment I/F 7660 is a communication interface that mediates connection between the microcomputer 7610 and various interior equipment 7760 existing in the vehicle. The vehicle interior equipment I/F 7660 may establish a wireless connection using a wireless communication protocol such as wireless LAN, Bluetooth (registered trademark), near field communication (NFC), or a wireless USB (WUSB). Furthermore, the vehicle interior equipment I/F 7660 may establish wired connection such as a universal serial bus (USB), a high-definition multimedia interface (HDMI (registered trademark)), or a mobile high-definition link (MHL) via a connection terminal not shown (and a cable if necessary). The vehicle interior equipment 7760 may include, for example, at least one of a mobile device or a wearable device possessed by an occupant, or an information device carried in or attached to the vehicle. Furthermore, the vehicle interior equipment 7760 may include a navigation device that performs a route search to an arbitrary destination. The vehicle interior equipment I/F 7660 exchanges control signals or data signals with these vehicle interior equipment 7760.

The in-vehicle network I/F 7680 is an interface mediating communication between the microcomputer 7610 and the communication network 7010. The in-vehicle network I/F 7680 transmits and receives signals and the like according to a predetermined protocol supported by the communication network 7010.

The microcomputer 7610 of the integrated control unit 7600 controls the vehicle control system 7000 in accordance with various programs on the basis of information acquired via at least one of the general-purpose communication I/F 7620, the dedicated communication I/F 7630, the positioning part 7640, the beacon reception part 7650, the vehicle interior equipment I/F 7660, or the in-vehicle network I/F 7680. For example, the microcomputer 7610 may operate a control target value of the drive force generation device, the steering mechanism, or the braking device on the basis of acquired information inside and outside the vehicle, and output a control command to the drive system control unit 7100. For example, the microcomputer 7610 may perform cooperative control for the purpose of function realization of an advanced driver assistance system (ADAS) including collision avoidance or impact mitigation of the vehicle, follow-up running based on inter-vehicle distance, vehicle speed maintenance running, vehicle collision warning, vehicle lane departure warning, or the like. Furthermore, the microcomputer 7610 may perform cooperative control for the purpose of automatic driving or the like by which a vehicle autonomously runs without depending on the operation of the driver by controlling the drive force generation device, the steering mechanism, the braking device, or the like on the basis of the acquired information on the surroundings of the vehicle.

The microcomputer 7610 may generate three-dimensional distance information between the vehicle and an object such as a surrounding structure or a person on the basis of the information acquired via at least one of the general-purpose communication I/F 7620, the dedicated communication I/F 7630, the positioning part 7640, the beacon reception part 7650, the vehicle interior equipment I/F 7660, or the in-vehicle network I/F 7680, and create local map information including peripheral information on the current position of the vehicle. Furthermore, the microcomputer 7610 may predict danger such as collision of a vehicle, approach of a pedestrian or the like, or entry into a road where traffic is stopped on the basis of acquired information to generate a warning signal. The warning signal may be, for example, a signal for generating an alarm sound or for turning on a warning lamp.

The audio image output part 7670 transmits an output signal of at least one of audio and image to an output device capable of visually or audibly notifying the occupant of the vehicle or the outside of the vehicle, of information. In the example of FIG. 22, as an output device, an audio speaker 7710, a display part 7720, and an instrument panel 7730 are illustrated. The display part 7720 may include at least one of an on-board display or a head-up display, for example. The display part 7720 may have an augmented reality (AR) display function. The output device may be other devices including a wearable device such as a headphone, a spectacular display worn by an occupant, a projector, a lamp, or the like other than these devices. In a case where the output device is a display device, the display device visually displays the result obtained by the various processing performed by the microcomputer 7610 or the information received from the other control unit in various formats such as text, image, table, or graph. Furthermore, in a case where the output device is an audio output device, the audio output device converts an audio signal including reproduced audio data, acoustic data, or the like into an analog signal, and outputs the result audibly.

Note that, in the example shown in FIG. 22, at least two control units connected via the communication network 7010 may be integrated as one control unit. Alternatively, each control unit may be constituted by a plurality of control units. Moreover, the vehicle control system 7000 may include another control unit not shown. Furthermore, in the above description, some or all of the functions carried out by any one of the control units may be performed by the other control unit. That is, as long as information is transmitted and received via the communication network 7010, predetermined operation processing may be performed by any control unit. Similarly, a sensor or device connected to any of the control units may be connected to another control unit, and a plurality of control units may transmit and receive detection information to and from each other via the communication network 7010.

Note that a computer program for realizing each function of the image processing device 11 according to the present embodiment described with reference to FIG. 1 can be mounted on any control unit or the like. Furthermore, it is possible to provide a computer readable recording medium in which such a computer program is stored. The recording medium is, for example, a magnetic disk, an optical disk, a magneto-optical disk, a flash memory, or the like. Furthermore, the computer program described above may be delivered via, for example, a network without using a recording medium.

In the vehicle control system 7000 described above, the image processing device 11 according to the present embodiment described with reference to FIG. 1 can be applied to the integrated control unit 7600 of the application example shown in FIG. 22. For example, the distortion correction part 12, the depth image synthesis part 14, and the viewpoint conversion image generation part 16 of the image processing device 11 correspond to the microcomputer 7610 of the integrated control unit 7600, and the visible image memory 13 and the depth image memory 15 correspond to the storage part 7690. For example, when the integrated control unit 7600 generates and outputs a viewpoint conversion image, the viewpoint conversion image can be displayed on the display part 7720.

Furthermore, at least a part of the components of the image processing device 11 described with reference to FIG. 1 may be realized in a module for the integrated control unit 7600 shown in FIG. 22 (for example, an integrated circuit module including one die). Alternatively, the image processing device 11 described with reference to FIG. 1 may be realized by a plurality of control units of the vehicle control system 7000 shown in FIG. 22.

<Example of Configuration Combination>

Note that, the present technology can also adopt the following configuration.

(1)

An image processing device including:

a determination part that determines a predetermined viewpoint of a viewpoint image related to periphery of a moving object in a case of viewing the moving object from the viewpoint according to a speed of the moving object that can move at an arbitrary speed;

a generation part that generates the viewpoint image that is a view from the viewpoint determined by the determination part; and

a synthesis part that synthesizes an image related to the moving object at a position where the moving object can exist in the viewpoint image.

(2)

The image processing device according to (1) described above,

in which, in a case where the speed of the moving object is a first speed, the determination part determines the viewpoint such that an angle of a line-of-sight direction from the viewpoint to a vertical direction is large as compared to a case of a second speed in which the speed of the moving object is lower than the first speed.

(3)

The image processing device according to (1) or (2) described above,

further including

an estimation part that estimates motion of another object in periphery of the moving object to determine a motion vector, in which the determination part calculates the speed of the moving object on the basis of the motion vector determined by the estimation part, and determines the viewpoint.

(4)

The image processing device according to (3) described above,

further including

a motion compensation part that compensates the another object captured in a past image of the periphery of the moving object captured at a past time point to a position where the another object should be located currently on the basis of the motion vector determined by the estimation part,

in which the synthesis part synthesizes an image related to the moving object at a position where the moving object can currently exist in the past image on which motion compensation has been performed by the motion compensation part.

(5)

The image processing device according to (4) described above,

in which the generation part performs projection conversion according to the viewpoint on an image synthesizing result obtained by the synthesis part synthesizing the image related to the moving object with the past image to generate the viewpoint image.

(6)

The image processing device according to any one of (1) to (5) described above,

further including:

a texture generation part that generates a texture of another object in the periphery of the moving object from an image acquired by capturing the periphery of the moving object; and

a three-dimensional model configuration part that configures a three-dimensional model of the another object in the periphery of the moving object from a depth image acquired by sensing the periphery of the moving object,

in which the generation part performs perspective projection conversion of generating a perspective projection image of a view of the three-dimensional model attached with the texture viewed from the viewpoint, and

the synthesis part synthesizes the image related to the moving object at a position where the moving object can exist in the perspective projection image to generate the viewpoint image.

(7)

The image processing device according to any one of (1) to (6) described above,

in which the determination part determines the viewpoint at a position further rearward than the moving object when the moving object is moving forward, and at a position further forward than the moving object when the moving object is moving backward.

(8)

The image processing device according to (7) described above,

in which the determination part determines the viewpoint such that an angle of a line-of-sight direction from the viewpoint to a vertical direction is large when the moving object is moving forward than when the moving object is moving backward.

(9)

The image processing device according to any one of (1) to (8) described above,

in which the determination part determines the viewpoint according to the speed of the moving object determined from at least two images of the periphery of the moving object captured at different timings.

(10)

The image processing device according to any one of (1) to (9) described above,

in which the determination part moves an origin of the viewpoint from a center of the moving object by a moving amount according to the speed of the moving object.

(11)

The image processing device according to (10) described above,

in which in a case where the moving object is moving backward, the determination part moves the origin to a rear portion of the moving object.

(12)

The image processing device according to any one of (1) to (11) described above,

further including: a distortion correction part that corrects distortion occurring in an image acquired by capturing the periphery of the moving object at a wide angle; and

a depth image synthesis part that performs processing of improving resolution of a depth image acquired by sensing the periphery of the moving object, using the image whose distortion has been corrected by the distortion correction part as a guide signal,

in which generation of the viewpoint image uses a past frame and a current frame of the image whose distortion has been corrected by the distortion correction part, and a past frame and a current frame of the depth image whose resolution has been improved by the depth image synthesis part.

(13)

An image processing method including:

by an image processing device that performs image processing

determining a predetermined viewpoint of a viewpoint image related to periphery of a moving object in a case of viewing the moving object from the viewpoint according to a speed of the moving object that can move at an arbitrary speed;

generating the viewpoint image that is a view from the viewpoint determined; and

synthesizing an image related to the moving object at a position where the moving object can exist in the viewpoint image.

(14)

A program that causes

a computer of an image processing device that performs image processing to perform image processing including:

determining a predetermined viewpoint of a viewpoint image related to periphery of a moving object in a case of viewing the moving object from the viewpoint according to a speed of the moving object that can move at an arbitrary speed;

generating the viewpoint image that is a view from the viewpoint determined; and

synthesizing an image related to the moving object at a position where the moving object can exist in the viewpoint image.

Note that the present embodiment is not limited to the above-described embodiments, and various modifications are possible without departing from the gist of the present disclosure. Furthermore, the effects described in the present specification are merely examples and are not intended to be limiting, and other effects may be provided.

### REFERENCE SIGNS LIST

11 Image processing device
12 Distortion correction part
13 Visible image memory
14 Depth image synthesis part
15 Depth image memory
16 Viewpoint conversion image generation part
21 and 22 Vehicle
23 RGB camera
24 Distance sensor
31 Motion estimation part
32 Motion compensation part
33 Image synthesis part
34 Storage part
35 Viewpoint determination part
36 Projection conversion part
41 Matching part
42 Texture generation part
43 Three-dimensional model configuration part
44 Perspective projection conversion part
45 Image synthesis part
46 Storage part
51 Parameter calculation part
52 θ lookup table storage part
53 r lookup table storage part
54 Viewpoint coordinate calculation part
55 Origin coordinate correction part
56 X lookup table storage part
57 Corrected viewpoint coordinate calculation part

1. An image processing device comprising:
a determination part that determines a predetermined viewpoint of a viewpoint image related to periphery of a moving object in a case of viewing the moving object from the viewpoint according to a speed of the moving object that can move at an arbitrary speed;
a generation part that generates the viewpoint image that is a view from the viewpoint determined by the determination part; and
a synthesis part that synthesizes an image related to the moving object at a position where the moving object can exist in the viewpoint image.

2. The image processing device according to claim 1,
wherein, in a case where the speed of the moving object is a first speed, the determination part determines the viewpoint such that an angle of a line-of-sight direction from the viewpoint to a vertical direction is large as compared to a case of a second speed in which the speed of the moving object is lower than the first speed.

3. The image processing device according to claim 1,
further comprising an estimation part that estimates motion of another object in periphery of the moving object to determine a motion vector,
wherein the determination part calculates the speed of the moving object on a basis of the motion vector determined by the estimation part, and determines the viewpoint.

4. The image processing device according to claim 3,
further comprising a motion compensation part that compensates the another object captured in a past image of the periphery of the moving object captured at a past time point to a position where the another object should be located currently on a basis of the motion vector determined by the estimation part,
wherein the synthesis part synthesizes an image related to the moving object at a position where the moving object can currently exist in the past image on which motion compensation has been performed by the motion compensation part.

5. The image processing device according to claim 4,
wherein the generation part performs projection conversion according to the viewpoint on an image synthesizing result obtained by the synthesis part synthesizing the image related to the moving object with the past image to generate the viewpoint image.

6. The image processing device according to claim 1,
further comprising:
a texture generation part that generates a texture of another object in the periphery of the moving object from an image acquired by capturing the periphery of the moving object; and
a three-dimensional model configuration part that configures a three-dimensional model of the another object in the periphery of the moving object from a depth image acquired by sensing the periphery of the moving object,
wherein the generation part performs perspective projection conversion of generating a perspective projection image of a view of the three-dimensional model attached with the texture viewed from the viewpoint, and
the synthesis part synthesizes the image related to the moving object at a position where the moving object can exist in the perspective projection image to generate the viewpoint image.

7. The image processing device according to claim 1,
wherein the determination part determines the viewpoint at a position further rearward than the moving object when the moving object is moving forward, and at a position further forward than the moving object when the moving object is moving backward.

8. The image processing device according to claim 7,
wherein the determination part determines the viewpoint such that an angle of a line-of-sight direction from the viewpoint to a vertical direction is large when the moving object is moving forward than when the moving object is moving backward.

9. The image processing device according to claim 1,
wherein the determination part determines the viewpoint according to the speed of the moving object determined from at least two images of the periphery of the moving object captured at different timings.

10. The image processing device according to claim 1,
wherein the determination part moves an origin of the viewpoint from a center of the moving object by a moving amount according to the speed of the moving object.

11. The image processing device according to claim 10,
wherein, in a case where the moving object is moving backward, the determination part moves the origin to a rear portion of the moving object.

12. The image processing device according to claim 1,
further comprising:
a distortion correction part that corrects distortion occurring in an image acquired by capturing the periphery of the moving object at a wide angle; and
a depth image synthesis part that performs processing of improving resolution of a depth image acquired by sensing the periphery of the moving object, using the image whose distortion has been corrected by the distortion correction part as a guide signal,
wherein generation of the viewpoint image uses a past frame and a current frame of the image whose distortion has been corrected by the distortion correction part, and a past frame and a current frame of the depth image whose resolution has been improved by the depth image synthesis part.

13. An image processing method comprising:
by an image processing device that performs image processing,
determining a predetermined viewpoint of a viewpoint image related to periphery of a moving object in a case of viewing the moving object from the viewpoint according to a speed of the moving object that can move at an arbitrary speed;
generating the viewpoint image that is a view from the viewpoint determined; and
synthesizing an image related to the moving object at a position where the moving object can exist in the viewpoint image.

14. A program that causes a computer of an image processing device that performs image processing to perform image processing comprising:
determining a predetermined viewpoint of a viewpoint image related to periphery of a moving object in a case of viewing the moving object from the viewpoint according to a speed of the moving object that can move at an arbitrary speed;
generating the viewpoint image that is a view from the viewpoint determined; and
synthesizing an image related to the moving object at a position where the moving object can exist in the viewpoint image.
